(19) United States
(12) Patent Application Publication
(10) Pub. No.: US 2006/0290974 A1
(43) Pub. Date: Dec. 28, 2006

(54) Image communication apparatus

(75) Inventors: Madoka Kano, Warabi-shi (JP); Koichi Kitamoto, Tokyo (JP); Shunichi Kumakura, Tokyo (JP); Motoaki Aoyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/257,436

(22) Filed: Oct. 24, 2005

(30) Foreign Application Priority Data
Jun. 22, 2005 (JP) JP2005-182252

(51) Int. Cl. G06K 15/00; G06F 15/00

(52) U.S. Cl. 358/1.15; 358/1.12

(57) ABSTRACT

There is described an image communication apparatus capable of supplying a user with the information for making a decision in taking a step against the current network quality. The image communication apparatus includes: a transmission section which transmits image data to an external device via a network; a network quality grasping section which grasps a quality of the network; a progress condition grasping section which grasps a progress condition of a transmission of image data with regard to the image data; and a display section which displays the quality of the network and the progress condition of transmission of the image data during transmission of the image data. Further, the display section displays the quality of the network and the progress condition of transmission of the image data simultaneously, and an estimated remaining time required for completion of a transmission of the image data being transmitted by the transmission section.

This application is based on Japanese Patent Application NO. 2005-182252 filed on Jun. 22, 2005 in Japanese Patent Office, the entire content of which is hereby incorporated by reference.

### BACKGROUND

1. Field of the Invention

The present invention relates to an image communication apparatus for transmitting and receiving image data via a communication network, particularly to an image communication apparatus equipped with a function for displaying network quality.

2. Description of the Related Art

Data communication speed is often affected by the communication network quality, and the reduction in communication speed often causes disadvantages of users. To solve this problem, many techniques have been proposed to notify users of the current network quality.

For example, in the VoIP (Voice Over Internet Protocol) telephone system, a delay will occur in the transmission of audio data, and continuation of smooth communication cannot be assured, if telephone conversation is carried out despite poor network quality. To solve this problem, a technique has been proposed to notify users of the network quality before or during a telephone conversation (Patent Document 1).

[Patent Document 1]
Tokkai 2001-237888 (Japanese Non-Examined Patent Publication)

In the case of telephone conversation, a user knows what to speak and what has been spoken. Accordingly, if the user is notified of network quality, the user can determine if conversation should be continued because it will be finished very soon, or conversation should be suspended and a telephone call should be made later since a long time is required to finish the present conversation.

In the meantime, in the case of such an image communication apparatus as a facsimile machine for sending and receiving image data, mere notification of the network quality does not help the user determine the best step that should be taken. For example, in some cases, the current data transmission should be continued despite poor network quality if the transmission ends very soon. However, mere notification of the network quality has not helped the user understand such situation and determine that the current data transmission should be continued, according to the conventional methods.

In case of poor network quality, the amount of data to be transmitted can be reduced and the communication time can also be reduced, if resolution is reduced. However, the user is unable to estimate the degree of improvement achieved by a particular method of alteration. Thus, it has been difficult for the user to take an adequate step.

### SUMMARY

In view of foregoing, the object of the present invention is to provide an image communication apparatus capable of supplying a user with the information for making a decision in taking a step against the current network quality.

The image communication apparatus comprises a transmission section which transmits image data to an external device via a network; a network quality grasping section which grasps a quality of the network; a progress condition grasping section which grasps a progress condition of a transmission of image data with regard to the image data being transmitted by the transmission section; and a display section which displays the quality of the network and the progress condition of transmission of the image data during transmission of the image data.

According to another aspect of the present invention, the image communication apparatus comprises a transmission section which transmits image data to an external device via a network; a network quality grasping section which grasps a quality of the network; a progress condition grasping section which grasps a progress condition of a job for transmitting image data; and a display section which displays the quality of the network and the progress condition of transmission of the image data during execution of the job.

According to another aspect of the present invention, the image communication apparatus comprises a transmission section which transmits image data to an external device via a network;

a network quality grasping section which grasps a quality of the network;

a remaining amount grasping section which grasps remaining amount for completion of a transmission of image data with regard to the image data being transmitted by the transmission section; and

a display section which displays the quality of the network and the remaining amount of transmission of the image data during transmission of the image data.

According to another aspect of the present invention, the image communication apparatus comprises a transmission section which transmits image data to an external device via a network; a network quality grasping section which grasps a quality of the network; a remaining amount grasping section which grasps remaining amount for completion of a job for transmitting image data; and a display section which displays the quality of the network and the remaining amount of transmission of the image data during execution of the job.

According to another aspect of the present invention, the image communication apparatus comprises a reception section which receives image data from an external device via a network; a network quality grasping section which grasps a quality of the network; a progress condition grasping section which grasps a progress condition of a reception of image data with regard to the image data being received by the reception section; and a display section which displays the quality of the network and the progress condition of reception of the image data during reception of the image data.

According to another aspect of the present invention, the image communication apparatus comprises a reception section which receives image data from an external device via a network; a network quality grasping section which grasps a quality of the network; a progress condition grasping section which grasps a progress condition of a job for reception image data; and a display section which displays the quality of the network and the progress condition of reception of the image data during execution of the job.

According to another aspect of the present invention, the image communication apparatus comprises a reception section which receives image data from an external device via a network; a network quality grasping section which grasps a quality of the network; a remaining amount grasping section which grasps remaining amount for completion of a reception of-image data with regard to the image data being received by the reception section; and a display section which displays the quality of the network and the remaining amount of reception of the image data during reception of the image data.

According to another aspect of the present invention, the image communication apparatus comprises a reception section which receives image data from an external device via a network; a network quality grasping section which grasps a quality of the network; a remaining amount grasping section which grasps remaining amount for completion of a job for reception image data; and a display section which displays the quality of the network and the remaining amount of reception of the image data during execution of the job.

The invention itself, together with further objects and attendant advantages, will best be understood by reference to the following detailed description taken in conjunction with the accompanying drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the configuration of an image communication apparatus as a first embodiment of the present invention;

FIG. 2 is an explanatory diagram showing an example of the configuration of an image communication system for transmission of image data, using the image communication apparatus as a first embodiment of the present invention;

FIG. 3 is an explanatory diagram showing an example of the message selection table to provide a reference for selecting the message displayed in response to the current network quality;

FIG. 4 is an explanatory diagram showing an example of the transmission-in-progress screen (for “Good” network quality) displayed during the transmission of image data using the facsimile function via the Internet;

FIG. 5 is a flow diagram representing the flow of the operation when the image communication apparatus transmits image data using the facsimile function via the Internet;

FIG. 6 is a flow diagram representing the flow of the operation of switching the screen displayed on the display section during the transmission of image data;

FIG. 7 is a flow diagram representing the flow of the operation of switching the display on the transmission-in-progress screen;

FIG. 8 is an explanatory diagram showing an example of the transmission-in-progress screen (for poor network quality) indicated when the image communication apparatus transmits image data using the facsimile function via the Internet;

FIG. 9 is an explanatory diagram showing an example of the transmission standby screen indicated before the image data is transmitted;

FIG. 10 is an explanatory diagram showing an example of a reading operation display screen indicated when a document is read;

FIG. 11 is an explanatory diagram showing an example of the connection operation display screen indicated;

FIG. 12 is an explanatory diagram showing an example of an attribute alteration screen for altering the attribute in the first altering mode during transmission;

FIG. 13 is an explanatory diagram showing an example of a suspension/re-transmission determining screen to select the screen for suspending transmission or altering the attribute in the second altering mode;

FIG. 14 is an explanatory diagram showing an example of a re-transmission attribute setting screen for altering the attribute in the second altering mode;

FIG. 15 is an explanatory diagram schematically showing how the screen of the display section is switched and displayed in response to the progress of the image transmission sequence;

FIG. 16 is a block diagram showing the configuration of the image communication apparatus as a second embodiment of the present invention;

FIG. 17 is an explanatory diagram showing an example of the reception-in-progress screen displayed during the reception of image data using the facsimile function via the Internet; and

FIG. 18 is an explanatory diagram schematically showing how the screen of the display section is switched and displayed in response to the progress of reception of the image data polling reception sequence.

DETAILED DESCRIPTION OF THE PREFERRED EMBODIMENT

The following describes the preferred embodiments of the present invention with reference to drawings:

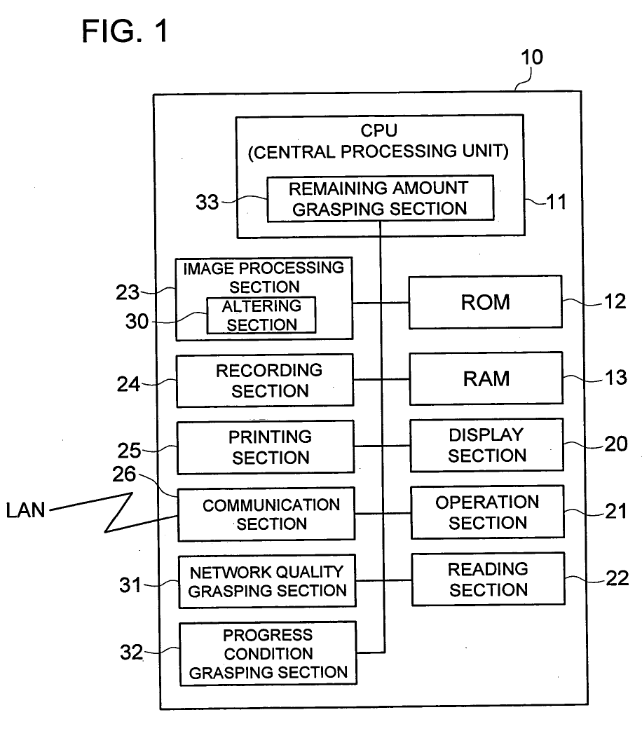

FIG. 1 shows the electrical configuration of an image communication apparatus 10 as a first embodiment of the present invention. For the first embodiment, the following describes the image communication apparatus 10 on the image data transmission side.

The image communication apparatus 10 is a multi-function peripheral incorporating: a facsimile function for exchanging image data via the LAN (Local Area Network) or Internet which includes the so-called Internet Facsimile function based on the Recommendations T.37 and T.38 of the ITU-T (International Telecommunication Union Telecommunication Standardization Sector), and IP (Internet Protocol) fax function); a copy function of reading the document and forming the copy image thereof on a recording medium; a scanner function for outputting the read data to an external section; and a printer function for printing according to the received print data. Any image data can be handled by the image communication apparatus 10 if it is configured in a visually recognizable form and can be outputted. No restriction is imposed on the type of the image data (e.g. photograph or character) or the format of the image data.

The image communication apparatus 10 includes a CPU (Central Processing Unit) 11 as a control section for administrative control of the operation, a ROM (Read Only Memory) 12 and a RAM (Random Access Memory) 13.

The ROM 12 stores the programs run by the CPU 11, and various fixed data. The RAM 13 provides a work memory for temporarily storing various types of data when the CPU 11 executes a program, and a page memory for storing image data.

Further, the CPU 11 is connected with a display section 20, an operation section 21, a reading section 22, an image processing section 23, a recording section 24, a printing section 25 and a communication section 26.

The display section 20 is composed of an LCD (liquid crystal display). In addition to various guiding functions, the display section 20 provides a display function to display the information on image communication by the facsimile function.

The operation section 21 accepts various operations. The operation section 21 provides the function of accepting, prior to starting the transmission, the setting of the attribute of image data at the time of transmission (hereinafter referred to as “attribute setting”), such as the color/monochromatic mode (hereinafter referred to as “image mode”) and resolution of the image data. It also provides the function of accepting the alteration of the current attribute setting (hereinafter referred to as “attribute alteration”) during the transmission of image data. The “attribute” of the image data in the sense in which it is used here refers to any element influencing the image data communication speed and communication time, such as enlargement/reduction ratio of an image and image quality mode, e.g. text image or photographic image, in addition to the image mode and the resolution of the image data. The operation section 21 is composed of various operation switches on the operation panel (not illustrated) and a touch panel for covering the surface of the display section 20.

The reading section 22 provides the function of reading the document image and inputting the corresponding image data to the image communication apparatus 10. The reading section 22 is provided with: a light source for applying light to a document; a line image sensor for reading the document for one line across the width; a shifting section for shifting the line-based reading position along the length of the document; and an optical path for leading the light reflected from the document, to the line image sensor so that an image is formed. The line sensor is made of a CCD (charge coupled device). The analog image signal outputted by the line image sensor is subjected to analog-to-digital conversion and is captured into the system as digital image data.

The image processing section 23 provides the function of enlarging or reducing the image data, and rotating the image in order to ensure that the image data is sent with the preset attribute.

The recording section 24 is a large-capacity recording apparatus for storing the image data compressed by the compression/expansion section (not illustrated). In this case, a HDD (Hard Disk Drive) is utilized.

The printing section 25 provides the function of forming an image corresponding to the image data on a recording medium by the electrophotographic process, and outputting that image. The printing section 25 is constructed as a so-called laser printer containing: a recording medium conveyance apparatus, a photoreceptor drum, a charging device, a laser unit, a development apparatus, a transfer/separation apparatus; a cleaning apparatus and a fixing apparatus.

The communication section 26 provides the transmission/reception function for encoding and decoding the image data, and transmitting and receiving it by the facsimile function. To put it in greater details, transmission and reception of image data is carried out using the transmission control procedure standardized according to the ITU-T (International Telecommunication Union Telecommunication Standardization Sector) recommendation T.38 (hereinafter referred to as T.38 or based on T.38). Using the transmission control procedure standardized according to the ITU-T recommendation T.30 (hereinafter referred to as T.30 or based on T.30) on the T.38 protocol, the communication section 26 divides various control signals based on the transmission control procedure of the G3 (Group 3) facsimile and image data into packets, and performs communication with the external terminal of the receiver (hereinafter referred to as “transmission destination terminal”) via the Internet. This arrangement allows image data to be exchanged on a real-time basis and, similarly to the case of the facsimile via the public line.

The communication section 26 calculates the image data transmission speed and the amount of remaining data at a predetermined interval and outputs the information obtained in this manner. The transmission speed signifies the amount of image data transmitted in the unit time, and is calculated based on the amount of the image data sent within a predetermined period of time. The amount of the remaining data represents the amount of image data being transmitted that is yet to be transmitted. To calculate the amount of the remaining data, the total amount of the overall image data the amount of the data having been transmitted are stored in the registry section (not illustrated) arranged on the communication section 26, and the difference between the total amount of data and the amount of the data having been transmitted is obtained.

The image processing section 23 provides the function of an altering section 30. The altering section 30 has the function of altering the image data so that it will conform to the alteration of the attribute accepted by the operation section 21.

The altering section 30 allows the attributes of the image mode and resolution to be altered. The image mode can be changed from color mode to monochromatic mode. With regard to the resolution, any resolution can be selected from among 600, 400, 300 and 200 dpi (dot per inch) if it is lower than the current set level. For example, if the color mode and the resolution of 600 dpi have been set, selection of three remaining resolutions in the color mode, and selection of four remaining resolutions in the monochromatic mode are possible. To put it another way, alteration of a total of seven attributes is possible.

Attribute alteration is carried out in two modes; the first altering mode and second altering mode, so that either mode can be selected by the user. In the first altering mode, the attribute of the image data being transmitted is altered and transmission is continued. In the second alteration mode, the attribute is altered and the transmission of the image data is restarted from the very beginning, (wherein the image data to be transmitted is re-transmitted from the first page). The data with the attribute altered is sent from the communication section 26.

The CPU 11 is further connected with a network quality grasping section 31 and a progress condition grasping section 32.

The network quality grasping section 31 has the function of grasping the network quality of the communication network connected to the communication section 26. The term “grasping” in the sense in which it is used here refers to acquisition of information on the network quality in such a way that the communication network quality can be displayed on the display section 20. In addition to getting information on the network quality by the network quality grasping section 31 itself inspecting the network quality, it is also possible to get information on network quality from an external apparatus.

The progress condition grasping section 32 provides the function of grasping the process conditions on the image data being transmitted. The progress conditions to be grasped, for example, information of the image data having already been transmitted out of total image data, in terms of the number pages and megabytes. Progress conditions can also be grasped by estimating the time from the start of transmission to completion, and counting the time having elapsed thereafter, in terms of minutes. Further, the information to be grasped can be given in terms of percentages of the number of pages and amount of data having been transmitted, and the estimated time, assuming that the levels at the time of completion of transmission are 100%.

The aforementioned number of pages of the image data and amount of the image data can be grasped by getting the aforementioned information as one job, wherein the operation of transmitting image data to one receiver terminal is assumed as the aforementioned one job. Further, when same image data is sent to a plurality of receiver terminals or plural image data are sent to one receiver terminal, the progress condition can be grasped with reference to these plurality of jobs as a whole. Further, it is also possible to get information on detailed progress condition, for example, it may be getting the information for each page and grasping the percentage of the pages having been transmitted out of the image data contained in one job.

Contrary to the examples of the progress conditions mentioned above, it is also possible to grasp the number of pages of the image data yet to be transmitted, the amount of data, the remaining time before the completion of transmission, and the percentage thereof.

As described above, the progress conditions can be any form of information if it indicates the amount of the data having been transmitted already, out of the overall image data to be transmitted. The present invention is not restricted to the aforementioned examples. The progress condition shown on the display section 20 can be of one type or combination with plural types. Further, the progress condition to be displayed can be selected from several types by the user.

The term “grasping” refers to acquisition of information on the progress condition in such a way that it can be displayed on the display section 20. The information on the progress condition can be obtained by the progress condition grasping section 32 itself managing and calculating the progress condition. It is also possible to get information on progress condition from an external apparatus.

In the present embodiment, the progress condition grasped by the progress condition grasping section 32 includes the total number of pages of image data and the number of pages being transmitted. The information on the total number of pages is obtained when image data is read by the reading section 22.

The number of pages being transmitted is obtained according to the control signal based on the T.30 exchanged between the communication section 26 and receiver terminal. To put it more specifically, the MPS (MultiPage Signal) and EOM (End of Message) signals sent to the receiver terminal, and the MCF (Message Confirmation) signal obtained from the receiver terminal are utilized. The MPS signal notifies that transmission of one page of the document has terminated, and the transmission will continue. The EOM signal notifies that transmission of one page of the document has terminated, and the attributes of image mode and resolution of the data being sent will be altered-from the next page. The MCF signal notifies that image data has been correctly received at the receiver terminal. The page number at the start of the image data transmission is “page 1”, and the number of receptions of the MCF signal subsequent to transmission of the MPS and EOM signals is added thereto. This procedure will provide the page number of the data currently being transmitted.

Further, the progress condition grasping section 32 incorporates the timer for counting the communication time from the start of transmission of the image data.

The CPU 11 provides the function of a remaining amount grasping section 33 for grasping the amount of the image data, being transmitted, to be processed previous to the termination of transmission. In the present embodiment, the remaining time previous to termination of transmission can be estimated as the remaining amount to be processed. The remaining time estimated by the remaining amount grasping section 33 is the remaining continuation time as the remaining time when transmission of the remaining image data is continued, without altering the attributes of the image data being transmitted.

The remaining continuation time is estimated by dividing the amount of the remaining data obtained from the communication section 26, by the transmission speed of the image data being transmitted. The transmission speed for obtaining this value is acquired from the amount of image data transmitted for most immediate one minute, excluding the time for exchange of control signals, for example.

The remaining amount grasping section 33 has a function of estimating the post-alteration remaining time as the remaining time when the attribute of the image data being transmitted in the first altering mode has been changed, and the estimated time when transmission of the image data with the attribute having been altered in the second altering mode is re-started from the beginning.

The amount of image data for estimating the post-alteration remaining time in the first altering mode is obtained by estimating the amount of image data when the attribute of the image data yet to be transmitted has been changed. Based on this amount of data, the post-alteration remaining time is estimated from the remaining time and the aforementioned transmission speed. The post-alteration remaining time is estimated for all types of alterable attributes from the current settings.

The amount of image data for obtaining the estimated time in the second altering mode is obtained by estimating the amount of image data when the attributes of all forms of image data to be re-transmitted have been altered. The procedure for getting the estimated time based on this amount of data is the same as that of post-alteration remaining time.

The network quality, progress condition and various forms of remaining time are displayed on the predetermined screen of the display section 20.

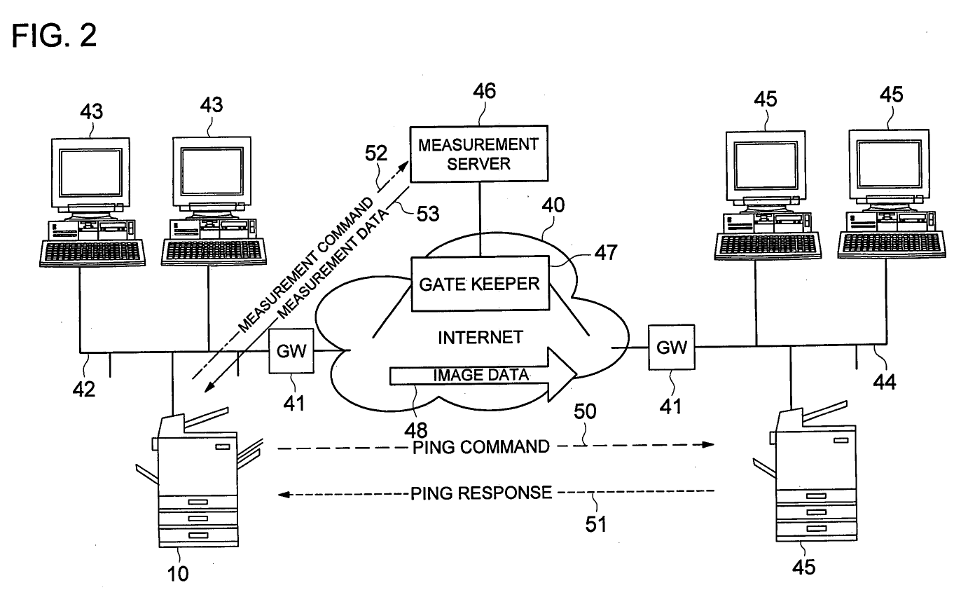

FIG. 2 shows an example of the configuration of an image communication system for transmission of image data, using the image communication apparatus 10 as an embodiment of the present invention.

This image communication system includes: a communication network composed of the. Internet 40, transmitting side LAN 42 and receiving end LAN 44; an image communication apparatus 10 connected to this communication network; a receiver terminal 45; and a measuring server 46. The receiver terminal 45 is composed of a multifunction peripheral and a PC (personal computer). Any apparatus capable of image exchange with the image communication apparatus 10 can be utilized.

Any communication network can be used in the present invention if it permits communication of image data. For example, the type of the network such as cable line or radio line, and the communication method used in the network are not restricted to the examples shown in the embodiment of the present invention.

The transmitting side LAN 42 and receiving end LAN 44 are connected to the Internet 40 via a GW (gateway) 41. The transmitting side LAN 42 is connected with the image communication apparatus 10 and PC 43. The receiving end LAN 44 is connected with the receiver terminal 45. A gate keeper 47 for managing the telephone number to call out the receiver terminal 45 is arranged in the Internet 40.

The image data sent from the image communication apparatus 10 is received by the receiver terminal 45 through the communication network. The arrow mark of the image data 48 shown in the Internet 40 indicates the direction in which image data is transmitted.

The following describes the procedures for grasping the communication network quality. There are available two procedures; a procedure for grasping the network quality at a specific time point prior to or during transmission, and the other for grasping it on a real-time basis during transmission.

The term “network quality” in the sense in which it is used here refers to the quality of the image data with reference to communication speed. To put it more specifically, it refers to the quality that may cause a delay or reduction in communication speed during transmission or reception.

The method of grasping the network quality at a specific time point will be described with reference to FIG. 2. This method uses the ping (Packet Internet Groper) or measurement data in some cases.

For example, when the ping is used, the ping command 50 (indicated by the arrow mark of bold broken line in the drawing) is sent to the IP (Internet Protocol) address of the receiver terminal 45. The ping command 50 is composed of four packets containing 32-byte data portion and is sent to the IP address specified in an interval of one second. The IP address is an 32-bit address for identifying the devices used for communication via the Internet 40.

The ping response command 51 (indicated by the arrow mark of fine broken line) is sent to the IP address of the image communication apparatus 10 by the receiver terminal 45 having received the ping command 50. The ping command 50 without modification is sent back as the ping response command 51.

The network quality grasping section 31 grasps the network quality according to the response time from transmission of the ping command 50 to reception of the ping response command 51. A longer response time is evaluated as showing the network quality that is more likely to cause delay or reduction in communication speed even in the image data communication. The ping command 50 and ping response command 51 can be used as a standard function in a device capable of communication via the Internet 40. This arrangement allows communication network quality to be grasped, without any other extra function required.

The above description refers to an example of sending the ping command to the receiver terminal 45 for receiving image data. It is also possible to grasp the communication network quality by sending the ping command to a predetermined terminal, instead of the receiver terminal 45, and measuring the response time.

When the measurement data is used to grasp the network quality, a measurement server 46 for supplying the measurement data is utilized. The image communication apparatus 10 connected to the transmitting side LAN 42 sends measurement command 52 (indicated by the arrow mark of one-dot chain line in the drawing) to the measurement server 46, and receives measurement data 53 (indicated by solid line in the drawing) as a response thereto from the measurement server 46.

The measurement data 53 data for grasping the network quality. It is composed of predetermined 100-packet data exchanged by TCP (Transmission Control Protocol), for example. The network quality grasping section 31 analyzes the received data and grasps the network quality based on: the number of requests for re-transmissions having been made due to the damage or loss of packets; the number of data items that have to be rearranged due to the faulty order of packet arrival; and the ratio between the time before reception of the measurement data 53 and the time-out interval. A network subjected to frequent requests for re-transmission of packets and frequent rearrangements is regarded as a network wherein communication speed is more likely to be reduced by the time spent for processing to meet these requests.

The packets that are exchanged according to the RTP (Real-time Transport Protocol) can be used for the measurement data 53. The header of he packet contains the records of the sequence number indicating the order of generation, and the time stamp indicating the time of generation. The sequence number provides information on the loss of packets and faulty order of arrival. The time stamp provides information on the delay wherein the interval of arrival is prolonged relative to the packet generation interval.

Further, it is also effective for the receiver terminal 45 to grasp the network quality using the measurement data 53. If the information obtained by the image communication apparatus 10 is exchanged with that obtained by the receiver terminal 45, network quality on both sides can be grasped. This method provides more detailed information on the network quality.

In FIG. 2, the measurement server 46 is arranged on the Internet 40. It can be mounted on the receiving end LAN 44. In this case, since the measurement server 46 is placed on the receiving end LAN 44 similarly to the receiver terminal 45, it is possible to grasp the network quality similar to that at the time of transmitting and receiving the image data.

When the RTP is used, it is possible to grasp the network quality by sampling pieces of random data flowing through the Internet 40. This arrangement allows the network quality to be grasped without the need of installing a specific measurement server 46.

The following describes the technique of grasping the network quality during transmission on a real-time basis. In this case, measures should be taken to ensure that such data as image data communication speed and rate of re-transmission are obtained on a continuous basis. Such data can be obtained whenever necessary during transmission. This arrangement allows the network quality to be obtained on a real-time basis, without the need of taking a special step to obtain the measurement data 53.

The network quality depends on the conditions of the transmitting side LAN 42 and receiving end LAN 44, as well as those of the Internet 40. The independent network quality on the transmitting side LAN 42 can be grasped using the CSMA/CD (Carrier Sense Multiple Access with Collision Detection) method for the management of communication among the devices of the transmitting side LAN 42.

To put it more specifically, after preparation has been completed for transmission of image data, a check is made to see if other data is flowing through the transmitting side LAN 42 or not (Carrier Sense). Then the waiting time prior to start of transmission is counted, and the number of collisions of data having occurred inside the transmitting side LAN 42 (Collision Detection) is counted. This arrangement provides information on the network quality. Such information can be obtained whenever necessary during transmission, and allows the network quality to be grasped on a real-time basis.

The network quality grasping section 31 can grasp the network quality by using any one of the aforementioned methods. A plurality of these methods can be used to get the information on network quality. The following describes the present embodiment using a technique of grasping the network quality at a specific time point prior to or during transmission.

According to predetermined criteria, the grasped network quality is evaluated and classified into three grades; “Good”, “Less congested” and “Much congested”. The graded network quality is indicated on the display section 20 under the heading of “communication status” so as to facilitate user's understanding. The criteria for determining the grade of the network quality are set according to the empirical rule or theoretical value. To obtain the overall network quality by the comprehensive study of the network quality grasped according to a plurality of methods, the network quality obtained according to each method is multiplied by the weighting factor conforming to the degree of influence, and the results are added together.

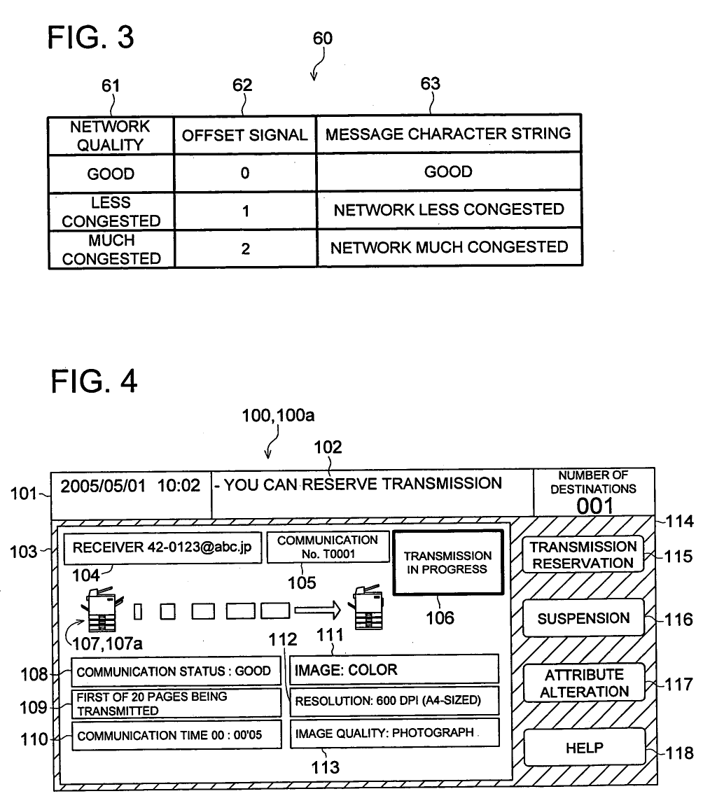

FIG. 3 shows a message selection table 60 for selecting the message displayed on the display section 20 by the network quality grasping section 31 in response to the network quality.

The message selection table 60 is composed of a network quality column 61, an offset signal column 62 and a message character column 63, arranged from left to right.

The network quality column 61 is divided into “Good”, “Less congested” and “Much congested” in response to the network quality grade. The offset signal column 62 indicates the values for the offset signals outputted from the network quality grasping section 31 to the CPU 11 in response to the network quality grade. Each offset value corresponds to the a predetermined message character string, and the “communication status” indicated on the display section 20 is switched and displayed in response to difference in the offset value to be outputted. The message character column 63 shows the message character string displayed on the display section 20 in response to the network quality grade.

When the network quality evaluated by the network quality grasping section 31 is “Good”, the offset signal “0” is outputted to the CPU 11, and the message character string of “Good” taken from the ROM 12 based on this signal is displayed on the display section 20. Similarly, when the network quality is “Less congested”, “Network less congested” is indicated based on the offset signal “1”. When the network quality is “Much congested”, “Network much congested” is indicated based on the offset signal “2”.

As described above, the character strings of “Less congested” and “Much congested” show the network quality. Not only that, these character strings gives a warning that the network quality fails to meet the requirements, when the network quality is not “Good”, namely, when predetermined conditions are not met. Since the warning is given in response to network quality, the user is automatically notified of the fact that network quality is the cause of the problem, if the transmission of image data does not complete soon.

FIG. 4 shows an example of the transmission-in-progress screen 100 displayed on the display section 20 during the transmission of image data using the facsimile function via the Internet. The transmission-in-progress screen 100 shown in this drawing is a transmission-in-progress screen 100a (for “Good”, network quality) displayed when the network quality is satisfactory.

A guide display section 101 is displayed on the top of the transmission-in-progress screen 100, an information display section 103 in the lower left-hand corner, and an operation button display section 114 in the right-hand corner.

A guide message 102 for showing current time of day and other information is displayed on the guide display section 101. The guide message 102 is switched in response to the result of evaluation of the network quality and selected operation.

The upper portion of the guide message 103 contains a receiver display column 104 for indicating the address of the receiver terminal 45 and the name of the receiver; a communication number display column 105 (“T” indicates the transmission job, and “R” the reception job); and an operation content display column 106 for showing the type of the operation being performed.

The receiver display column 104 is switched in response to the information obtained from the receiver terminal 45. For example, according to the transmission control procedure based on the T.30, it is possible to obtain the identification information for identifying the receiver terminal 45 such as the address of the receiver. If the identification information having been obtained is matched with the information stored in advance in the image communication apparatus 10 and is registered in the form associated with the names such as the company name and address, the receiver address displayed on the receiver display column 104 is switched to the names such as the company name and address, which are then displayed.

A network quality display diagram 107 is displayed below the receiver display column 104 and communication number display column 105. The network quality display diagram 107 is an image diagram shown to ensure that the network quality can be grasped intuitively. For example, in the network quality display diagram 107a (for “Good” network quality), the schematic diagrams of the multifunction peripheral given at both right and left ends show the image communication apparatuses on the transmitting and receiving sides, respectively. The rectangular diagram and arrow mark located in-between indicate how data is transmitted. The height of the rectangular diagram is constant and the width increases as one approaches the receiving end. This shows that the network quality is satisfactory. The arrow mark reaches the receiving end. This shows that transmission of image data has not problem. The network quality display diagram 107 is switched and displayed in conformity to the message character string selected by the message selection table 60.

The columns shown below the network quality display diagram 107 include:

a network quality display column 108 for displaying the message character string selected in conformity to the network quality;

a transmission page number display column 109 for showing the page number of the data being transmitted and the total number of pages;

a communication time display column 110 for displaying the communication time;

an image mode display column 111 for displaying the image mode settings;

a resolution display column 112 for displaying the resolution settings; and

an image quality display column 113 for showing the setting in response to the image data processing method. The image quality display column 113 shows the result of selecting the image mode set in such a way that proper processing will be applied according to whether the scanned document is a photograph, a text document or a document containing both the photograph and text. This image mode can be selected by the user or can be automatically set according to the result of document scanning.

The network quality display diagram 107, network quality display column 108, transmission page number display column 109 and communication time display column 110 are displayed correctively in the middle position on the left-hand side of the transmission-in-progress screen 100 so that the network quality and progress conditions can be grasped easily. This arrangement allows the user to watch them to make a comprehensive decision to determine if the attribute must be changed or not, when the network quality is poor. Particularly in the case of an image communication apparatus 10 wherein the scanned image data is transmitted by reading out from the memory, the progress condition cannot be checked from the condition how the documents on the document accommodation tray are read sequentially. In such a case, display of the progress conditions is very helpful.

The operation button display section 114 indicates the button for performing various operations that can be selected by the user. To put it more specifically, it contains a transmission reservation button 115 for displaying the screen for reserving the next image communication job in addition to the job being executed; a suspension button 116 for suspending transmission; an attribute alteration button 117 for altering the attribute in the first altering mode; and a help button 118 for selecting the help display.

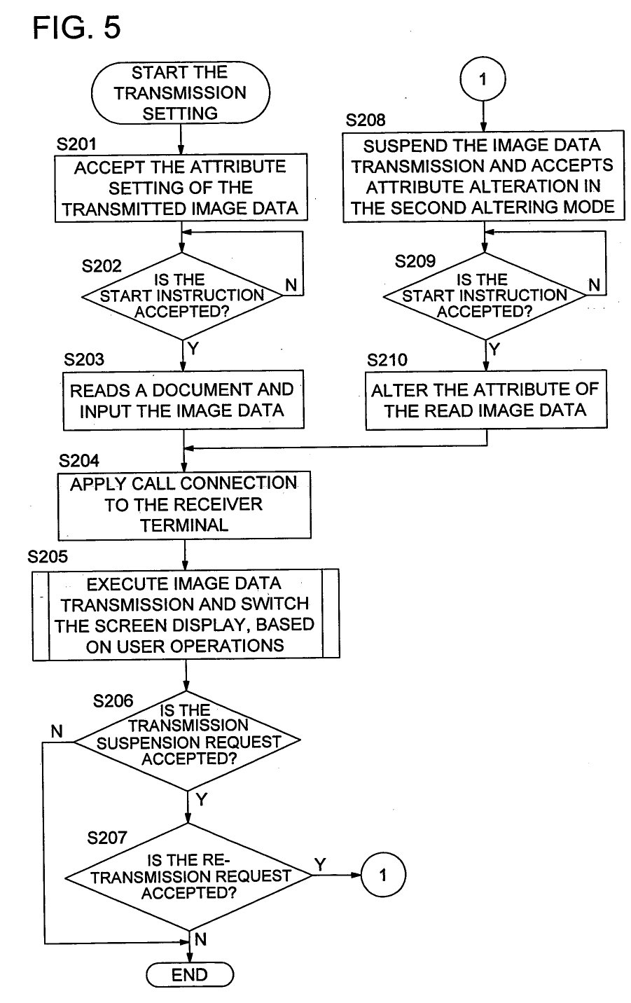

FIG. 5 shows the flow of the operation when the image communication apparatus 10 transmits image data using the facsimile function via the Internet.

When the operation section 21 has received various attribute settings of the image data to be transmitted (Step S201), the Start button (not illustrated) is pressed and the system waits until it receives the start instruction (N in Step S202). Upon receipt of the start instruction (Y in Step S202), the document is scanned and image data is inputted (Step S203).

Then the receiver terminal 45 is called up and connection operation (hereinafter referred to as “call connection”) is performed for communication using the facsimile function via the Internet (Step S204). The image data is transmitted and the screen display is switched in response to the user operation or a predetermined processing (Step S205).

If transmission suspension request is not accepted during the transmission (N in Step S206), the operation terminates at the completion of transmission (END).

When the re-transmission is not accepted (N in Step S207) even if transmission has suspended (Y in Step S206), the operation terminates directly (END).

If transmission has been suspended and the re-transmission request to re-transmit the image data from the beginning has been accepted (Y in Step S207), the image data is suspended and a predetermined screen is indicated. Then the attribute alteration is accepted in the second altering mode (Step S208), and the system waits until it receives the start instruction (N in Step S209).

Upon receipt of the start instruction (Y in Step S209), image conversion processing is applied to the scanned image data according to the attribute alteration so that the attribute is altered (Step S210). Then the system goes back to the call connection with the receiver terminal 45 (to Step S204).

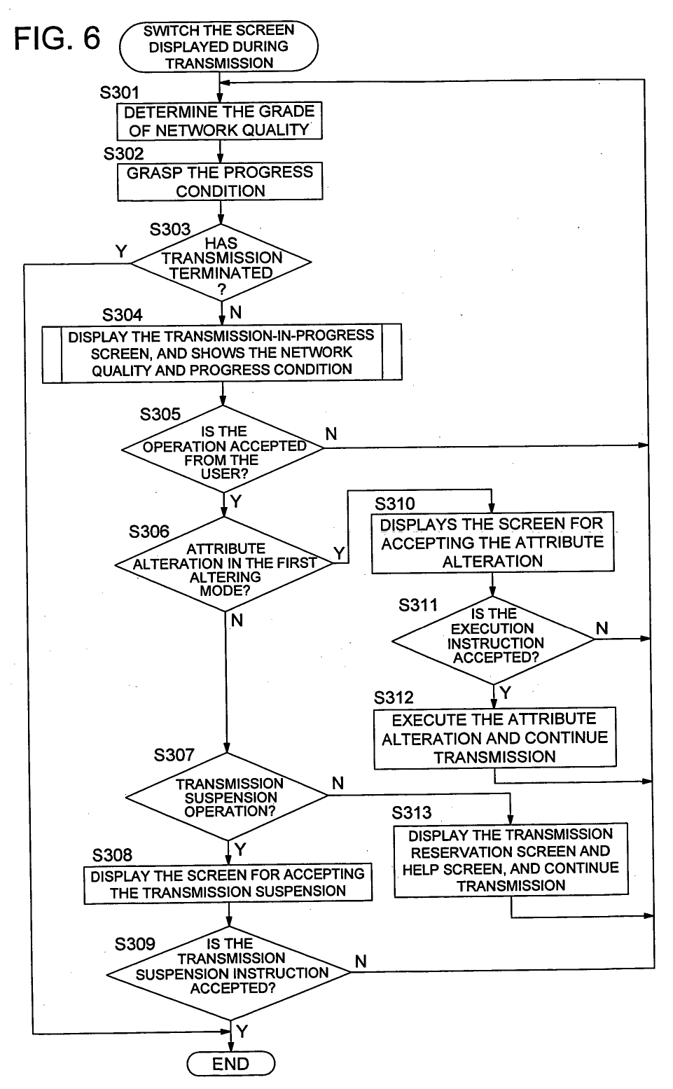

FIG. 6 shows the flow of the operation of switching the screen displayed on the display section (corresponding to Step S205 in FIG. 5) according to the user operation and others during the transmission of image data.

While the image data is transmitted, the network quality is grasped and the grade is determined (Step S301). The progress condition is grasped at the same time (Step S302). Upon termination of transmission (Y in Step S303), the operation will terminate directly (END).

When transmission continues (N in Step S303), the transmission-in-progress screen 100 is displayed, and the grade of the network quality and progress condition is displayed on the transmission-in-progress screen 100 (Step S304). Unless there is any operation by the user (N in Step S305), the operations from Step S301 to Step S304 will be repeated (to Step S301).

If the operation by the user has been accepted (Y in Step S305), the screen for accepting the attribute alteration is displayed (Step S310), if that operation is the operation for attribute alteration in the first altering mode (Y in Step S306). If attribute alteration execution instruction has not been accepted (N in Step S311), transmission continued just the way it is (to Step S301). If attribute alteration execution instruction has been accepted (Yes in Step S311), attribute alteration is executed for the specified page (Step S312) and transmission continues (to Step S301).

If the operation accepted from the user is not the operation for attribute alteration in the first altering mode (N in Step S306), but is the operation other than transmission suspension such as transmission reservation or help display (N in Step S307), then the screen corresponding to each operation is displayed (Step S313) and transmission continues (to Step S301).

If the operation having been accepted is the operation for transmission suspension (Y in Step S307), the screen for accepting the execution thereof is displayed (Step S308). If the transmission suspension instruction has been accepted (Y in Step S309), the operation terminates (END). If transmission suspension has been cancelled on the accept screen (N in Step S309), transmission continues just as the way it is (to Step S301).

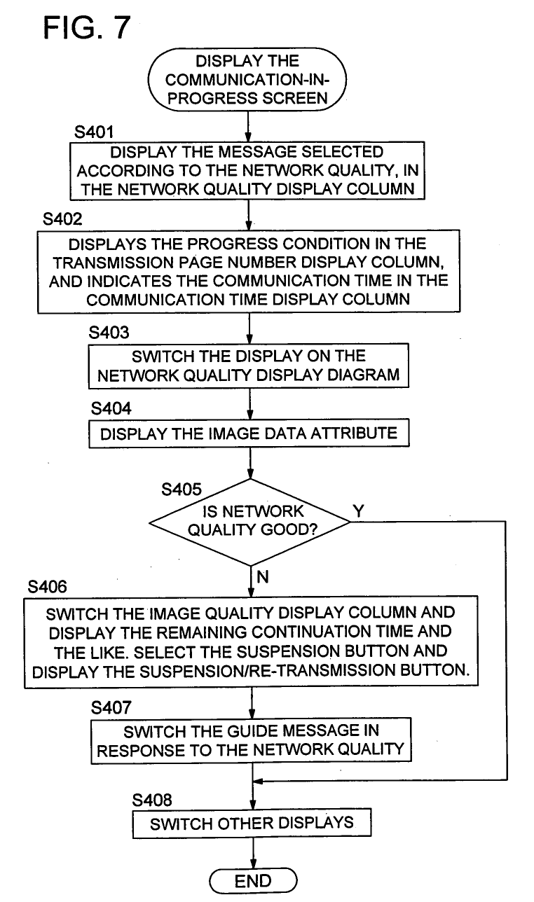

FIG. 7 shows the flow of the operation of switching the display (corresponding to the operation of Step S304 in FIG. 6) of the transmission-in-progress screen 100.

In the first place, the message character string selected from the results of evaluating the network quality is displayed in the network quality display column 108 (Step S401). The progress condition is displayed in the transmission page number display column 109, and the communication time is indicated in the communication time display column 110 (Step S402). Then the display on the network quality display diagram 107 in response to the selected message character string is switched (Step S403).

This is followed by the step of displaying the image data attribute in the image mode display column 111, resolution display column 112 and image quality display column 113 (Step S404). If the network quality is satisfactory (Y in Step S405), other display such as the address display in the receiver display column 104 is given (Step S408), and the operation terminates (END).

If the network quality is poor, network quality evaluation result corresponds to the grade “Less congested” or “Much congested” (N in Step S405), then the image quality display column 113 is switched to a new display column, and the remaining page number, the remaining continuation time and attribute of the image data being transmitted are displayed (Step S406). Further, the “suspension/re-transmission button” for selecting the suspension of transmission or attribute alteration in the second altering mode is switched to the suspension button 116, which is displayed (Step S406).

Then the guide message 102 is switched in response to network quality (Step S407), and other display is also switched as required (Step S408), thereby terminating the operation (Step S408) (END).

The image communication apparatus 10 repeats the aforementioned operations at a predetermined interval. The transmission-in-progress screen 100 shows the updated network quality and progress condition.

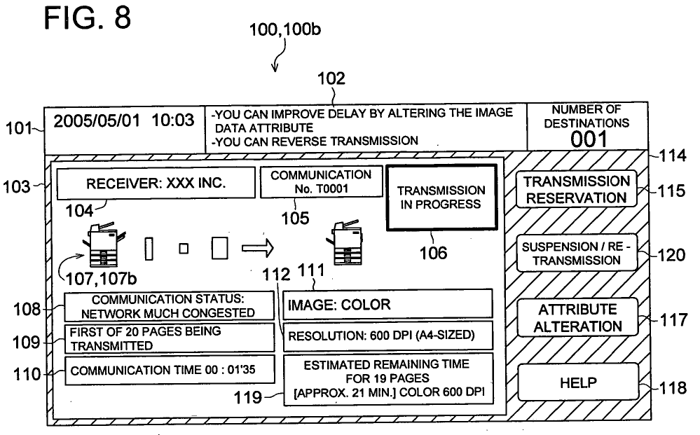

FIG. 8 shows an example of the transmission-in-progress screen 100 wherein the displayed items have been changed according to the flow illustrated in FIG. 7. The transmission-in-progress screen 100 shown therein is the transmission-in-progress screen (congested) 100b displayed when the network quality is poor. The following describes the portion wherein the display is switched, as compared with the transmission-in-progress screen 100a (“Good” network quality) described with reference to FIG. 4.

The guide message 102 contains the display to provide information on the method of solving the problem of delay. When the network quality fails to meet the predetermined requirements, the display gives a message of warning that the network quality fails to meet the predetermined requirements. The guide message 102 further gives a warning that transmission will not be carried out smoothly if the user fails to take the predetermined step.

The network quality display diagram 107 is switched over to the network quality display diagram 107 (congested network) 107b. The network quality display diagram 107 (congested network) 107b gives a warning that the network quality is poor, when the height of the rectangular drawing schematically showing the image data transmission is not uniform. It further gives a warning that image data transmission is not carried out smoothly, when the arrow mark does not reach the multifunction peripheral.

In the network quality display column 108, a message character string “Network much congested” appears as a warning, based on the evaluation of “Much congested” by the network quality grasping section 31. A message character string “Network less congested” appears when “Less congested” is the result of evaluation by the network quality grasping section 31.

A remaining time display column 119 is shown instead of the image quality display column 113. The remaining time display column 119 displays the remaining number of pages of the image data being transmitted that is yet to be transmitted, and the remaining continuation time in case of continued transmission without the attribute being altered.

Further, the suspension/re-transmission button 120 is displayed instead of the suspension button 116. Indication of this button allows the transmission to be suspended by the suspension button 116 as shown in FIG. 4, and permits the attribute to be altered in the process of transmission in the first altering mode by the attribute alteration button 117. Not only that, indication of this button makes it possible to select the second altering mode (a mode wherein not only the image data attributes are partially altered, but also the setting is performed again to ensure that all the image data will have the same attribute), and to re-transmit all image data having the same attribute. The details of the operation will be described with reference to the explanation of the suspension/re-operation determining screen. The suspension button 116 is removed from the operation button display section 114. This signifies that the job being transmitted can be suspended by the operation on the suspension/re-operation determining screen. The details of this operation will be described later.

As described above, the arrangement is so made that a specific attribute alteration can be selected, only when the network quality is satisfactory. This arrangement prevents the possible error of re-transmitting the image data subsequent to attribute alteration, despite satisfactory network quality. In the present embodiment, the attribute alteration button 117 is always displayed on the transmission-in-progress screen 100, and the attribute can be altered in response to the user's request. It is also possible to arrange such a configuration that display is switched only when the network quality is poor, similarly to the case of the suspension/re-transmission button 120.

As described above, the most-updated network quality and progress condition are always displayed simultaneously during image data transmission. When the network quality is poor, this arrangement allows the user to refer to the aforementioned information and to determine a proper step to be taken. At the same time, various forms of data for evaluation such as the remaining continuation time and remaining number of pages are displayed. Thus, these pieces of information are studied comprehensively, even if the network quality is poor. If the termination of transmission is very close, the user can wait without altering the attribute. Further, communication time is displayed in the communication time display column 110. This allows the user to consider the best step to be taken, based on the time spent on image data transmission so far. For example, ten minutes have passed when sixty percent of the image data had been sent, and the user does not require immediate termination of the transmission. Then, without having to refer to the remaining time, the user can wait termination of the transmission without changing the attribute.

Here the displays of the network quality display diagram (congested) 107b, network quality display column 108, remaining time display column 119, guide message 102 and others are enhanced using a standardized format. For example, these displays are given in red when the network quality is poor. This arrangement ensures that warning messages displayed separately on the transmission-in-progress screen (congested) 100b will be understood as being interrelated with one another. This will allows the user to understand that the network quality is poor and to find out a solution to this problem easily.

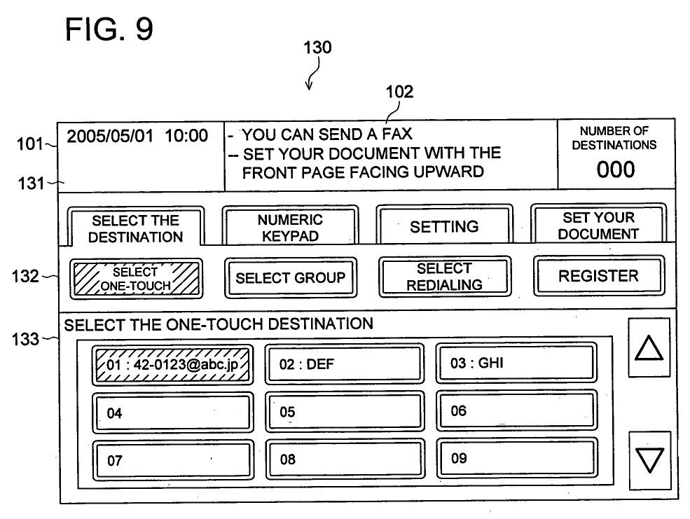

FIG. 9 shows an example of the transmission standby screen 130 displayed prior to start of the facsimile transmission.

The transmission standby screen 130 is designed to allow the display to be switched, and to permit various settings and selections to be made. FIG. 9 shows the screen when the destination of the receiver terminal 45 is selected.

A guide display section 101 is displayed on the top of the transmission standby screen 130, a setting screen selection column 131 in the lower portion, a destination selection method column 132 in the further lower position, and a destination selection column 133 in the bottom position.

The guide message 102 is displayed on the guide display section 101 to indicate that transmission data using the facsimile function via the Internet is possible. On the setting screen selection column 131, various setting items that can be set through the transmission standby screen 130 are displayed in the form of tab buttons. The display on the lower portion of the setting screen selection column 131 is switched by selecting any one of the buttons. Here the “Destination selection button” is selected.

The buttons for switching the destination selection method for specifying the receiver terminal 45 and the screen for recording the destination are displayed in the destination selection method column 132. Here “One-touch selection button” indicated in a solid form is selected and destination selection column 133 appears. In the destination selection column 133, the selection buttons having an indication of the destination registered in advance are arranged in several rows. One or more buttons are pressed according to the instructions, and the selected button will be indicated in a solid form so that the receiver terminal 45 is determined. This operation starts the transmission of image data to the destination selected by pressing the start button (not illustrated) on the operation panel.

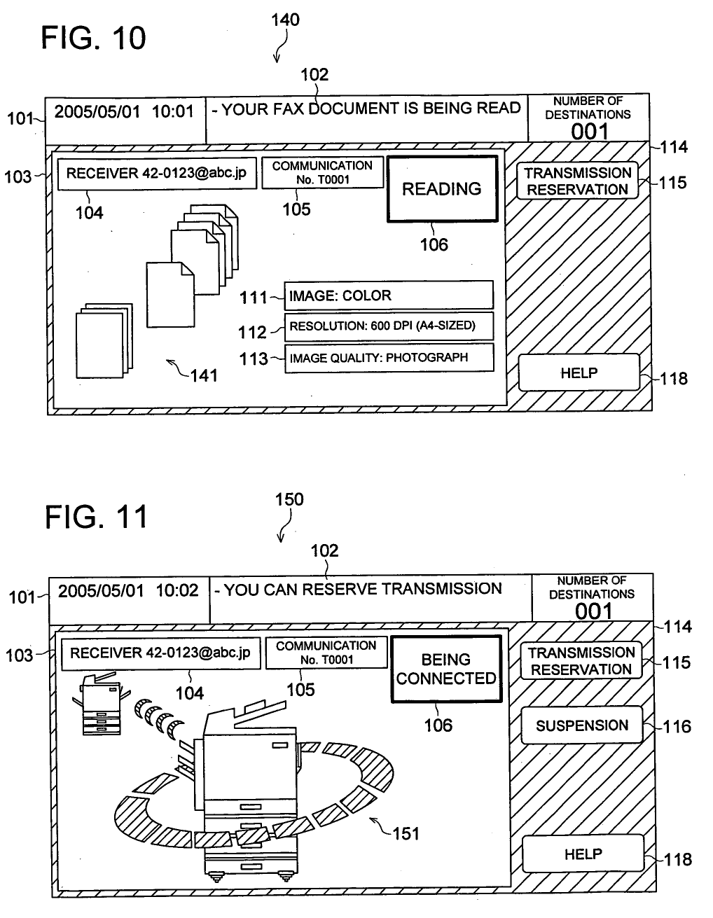

FIG. 10 shows an example of the reading operation display screen 140 displayed when the document is being read. The guide message 102 is displayed on the guide display section 101 to show that the document is being read. The receiver display column 104 and image mode display column 111 are indicated on the information display section 103 so that the destination and image data attribute can be identified. Particularly, “Reading in progress” is indicated in the operation content display column 106. At the same time, the reading operation display diagram 141 for visual representation of the current status is displayed. Only the buttons for operations that can be accepted during this operation are indicated on the operation button display section 114.

FIG. 11 shows an example of the connection operation display screen 150 displayed during call connection to the receiver terminal 45. The operation content display column 106 showing “Connection in progress” and the connection operation display diagram 151 for visual representation of the current status are displayed on the information display section 103.

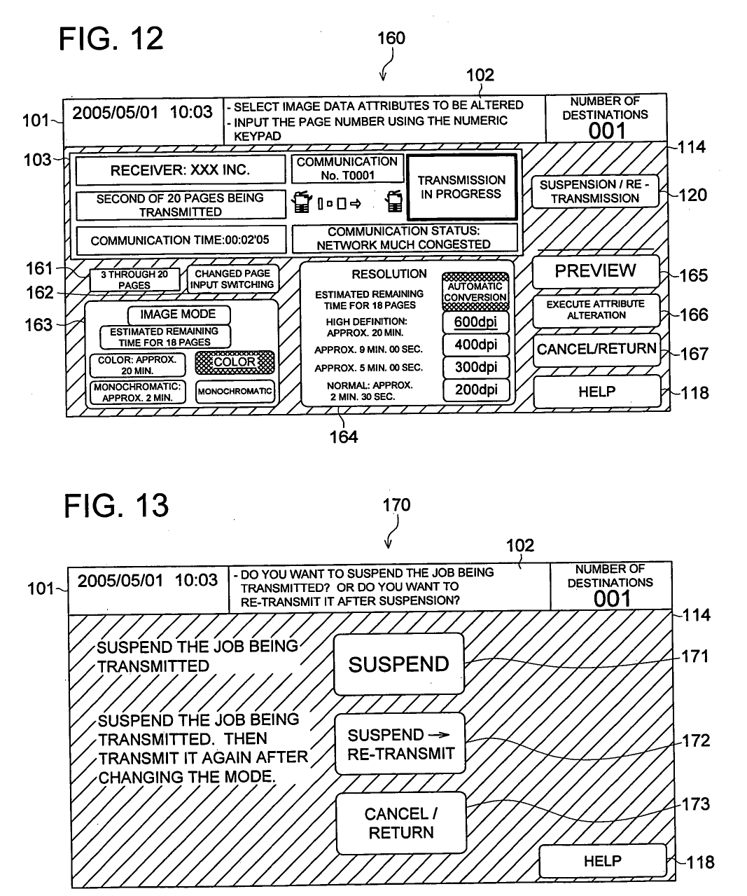

FIG. 12 shows an example of an attribute alteration screen 160 for altering the attribute in the first altering mode. The attribute alteration screen 160 is displayed by pressing the attribute alteration button 117 of transmission-in-progress screen 100 during transmission. Operation details are shown in the guide message 102 of the guide display section 101.

The number of the display columns appearing on the information display section 103 of the attribute alteration screen 160 is smaller than that on the transmission-in-progress screen 100. The indication space itself is smaller, and the newly displayed parts include an altered page designation column 161, an altered page input switch button 162, an image data alteration area 163, a resolution altered area 164, a preview button 165 for checking the image subsequent to attribute alteration, an attribute alteration execution button 166 and a cancel button 167.

The altered page designation column 161 accepts the designation of the page number subjected to attribute alteration. The page number can be inputted directly from the numeric keypad on the operation panel. The page number can be inputted each of the “alteration initiation page column” on the left side and “alteration termination page column” on the right side. To input the information in each column, the underline of the page number indicated in the altered page designation column 161 moves every time the altered page input switch button 162 is pressed. This procedure allows switching to be performed.

The image data alteration area 163 accepts the designation of image mode attribute alteration. A guide showing the details displayed in that area is indicated above the image data alteration area 163. The “remaining page number” of the image data whose transmission is not yet terminated is further indicated. On the lower right side of these indications, two selection buttons—“Color mode” and “Monochromatic mode”—are displayed in a single file. In the image mode having been selected, an underline is given and crosshatching is indicated. The remaining continuation time and post-alteration remaining time when the remaining page is sent in each image mode are displayed as “Remaining time” on the left side of each button. In the example shown in FIG. 12, the color mode is selected and remaining continuation time is about 20 minutes. When the mode is changed into the monochromatic mode, the post-alteration remaining time is reduced to about two minutes.

Alteration of resolution is accepted in the resolution altered area 164. “Resolution” is indicated above the resolution altered area 164 to show the contents display in the area. Further, the remaining number of pages is also indicated. On the right of these indications, “Automatic alteration” selection button and four selection buttons—“600 dpi”, “400 dpi”, “300 dpi” and “200 dpi”—are displayed in a single file. The selected button is shown in a crosshatched form, and the resolution having been selected is underlined. In the present embodiment, the “Automatic alteration” is selected by setting prior to initiation of the transmission. As a result, transmission is carried out at a resolution of 600 dpi. This selection button is underlined. When the Automatic alteration is selected, the highest of the resolutions of the image data that can be exchanged between the image communication apparatus 10 and receiver terminal 45 is automatically selected as the attribute set value. The remaining time direction and post-alteration remaining time at each resolution are indicated on the left side of the four selection buttons specifying the resolution.

The post-alteration remaining time indicated on the image data alteration area 163 and resolution altered area 164 is calculated again in conformity to the result of attribute alteration. For example, when the monochromatic mode is selected by the image data alteration area 163, the indication of the post-alteration remaining time at 600 dpi of the resolution altered area 164 is switched over to “Approx. 2 min.”. Other resolutions re-calculated in the monochromatic mode are indicated. When the attribute alteration is made in the resolution altered area 164, the result of alteration is reflected in each indication of the post-alteration remaining time in the image data alteration area 163.

As described above, the remaining continuation time and post-alteration remaining time are indicated in the form associated with the contents of the attribute alteration. This arrangement allows the user to select the attribute meeting the requirements, out of a plurality of attributes that can be altered.

Attribute alteration is executed by pressing the attribute alteration execution button 166 after termination of the setting of the altered page designation column 161, image data alteration area 163 and resolution altered area 164. The screen display is switched over to the transmission-in-progress screen 100.

It is also possible to arrange such a configuration that the selection button for the attribute that cannot be selected here is displayed in the gray-out mode so that the alteration is not accepted. For example, when the attribute is set at a resolution of 300 dpi, measures are taken to ensure that the selection buttons of “600 dpi” and “400 dpi” cannot be selected. Then the user can easily identify the attribute that cannot be altered.

As described above, if arrangements are made to display the attributes that can be altered by the altering section 30 and/or the alternatives of the attributes to be set, practical alternatives can be given to the user having determined that some measures should be taken against poor network quality. If further arrangements are made to display the remaining time in conformity to the contents of the attribute alteration, the user is allowed to make a desired attribute alteration.

FIG. 13 shows an example of a suspension/re-transmission determining screen 170 to select the screen for suspending transmission or altering the attribute in the second altering mode. The suspension/re-transmission determining screen 170 will appear by pressing the suspension/re-transmission button 120 of the transmission-in-progress screen (congested) 100b and attribute alteration screen 160.

The guide message 102 of the guide display section 101 contains a message for checking if the suspension of the job being transmitted can be executed or not. Only the operation button display section 114 is displayed below the guide display section 101. The operation button display section 114 displays a suspension button 171 for suspending the job being transmitted; a re-transmission button 172 for suspending the transmission and altering the attribute in the second altering mode; a cancel button 173 for canceling the suspension and re-transmission; and a help button 118.

Pressing the suspension button 171 allows transmission to be suspended so that the screen is switched over to the transmission standby screen 130. Pressing the re-transmission button 172 suspends the transmission, and the screen is switched over to the re-transmission attribute setting screen for accepting attribute alteration in the second altering mode. When the cancel button 173 is pressed, the screen is switched over to the transmission-in-progress screen 100. Transmission is continued out as before.

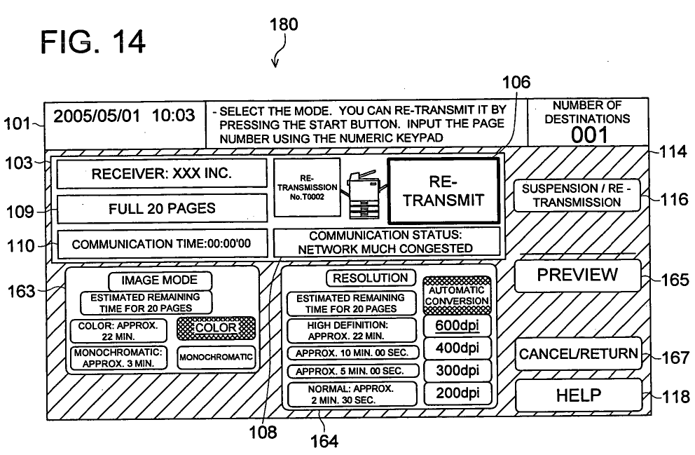

FIG. 14 shows an example of a re-transmission attribute setting screen 180 for altering the attribute in the second altering mode. The structure of the re-transmission attribute setting screen 180 is almost the same as that of the attribute alteration screen 160, except that the display of the information display section 103 and buttons of the operation button display section 114 are partly different.

The difference from the attribute alteration screen 160 is that the display in the operation content display column 106 of the information display section 103 is replaced by “re-transmission”; only the number of all pages is displayed in the transmission page number display column 109 since re-transmission is not yet started; and the display of the communication time display column 110 is not reset.

In the operation button display section 114, there is no display in the altered page designation column 161 since page designation is carried out; the estimated continuation time for re-transmission of all pages is indicated in the image data alteration area 163 and resolution altered area 164; and the attribute alteration execution button 166 is not displayed since re-transmission execution is instructed from the start button of the operation panel.

When attribute setting is made at the time of re-transmission, consistency of the transmitted image is not ruined even if the attribute of the document being transmitted in the color mode has been altered to monochromatic mode in the middle of transmission, for example.

In the case of the second altering mode as well, the estimated time is displayed in the form associated with the contents of the attribute alteration. This arrangement allows the user to select a desired attribute out of a plurality of attributes that can be changed.

As described above, the screen displayed on the display section 20 and the contents of the display are switched freely in response to the progress of the image communication and the user's instruction. The following describes the switching of the display screen with reference to the image transmission sequence to the receiver terminal 45.

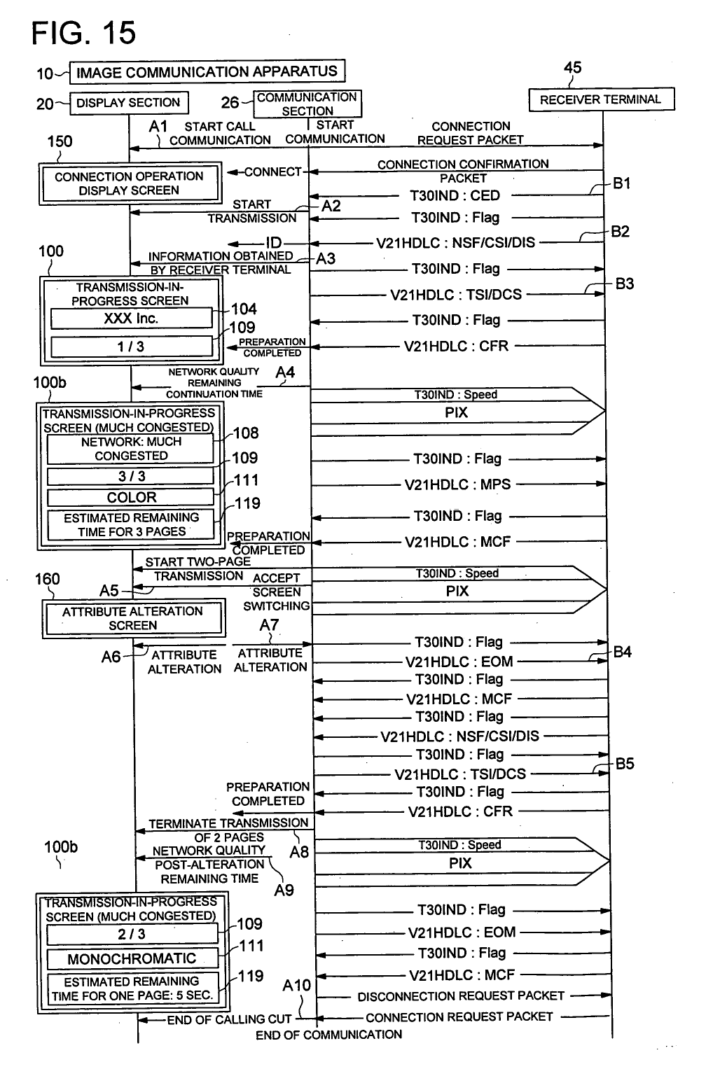

FIG. 15 schematically shows how the screen of the display section is switched in response to the progress of the image transmission sequence. The following describes the case wherein the image communication apparatus 10 transmits three-page image data in the color mode, and the attribute is altered in such a way as to change the image mode to the monochromatic mode in the middle of transmission.

In FIG. 15, image data is sent from the image communication apparatus 10 to the receiver terminal 45. The image communication apparatus 10 displays the display section 20 and communication section 26 on a selective basis. The vertical axis of the display section 20 of the image communication apparatus 10, the communication section 26 and the receiver terminal 45 indicate the time axis, which advances from top to bottom.

The arrow mark between the communication section 26 of the image communication apparatus 10 and receiver terminal 45 indicates various transmission control signals and image data in the facsimile function. The direction of the arrow is the same as the direction in which data is transmitted.

The indication attached to each arrow represents the signal and data exchanged in the communication. “T30IND: CED” denotes the CED (Caller Entered Digits), and “T30IND: flag” denotes the preamble signal for synchronization. The signals assigned with “V21HDLC” are various control signals. “V21HDLC” signifies that the signal is sent by the signal processing method (300 bps (bit per second) and full-duplex communication) based on the ITU-T Recommendation V.21, according to the transmission control procedure based on the HDLC (High-level Data Link Control procedure). “T30IND: Speed” denotes a training signal and “PIX” denotes the image data.

The arrow mark between the communication section 26 and display section 20 of the image communication apparatus 10 indicates the processing and signal inside the image communication apparatus 10. The description with the arrow signifies the details of the processing and signal. The direction of the arrow is the same as that for image transmission sequence. The arrow reaching the time axis shows that the information superimposed on the signal is reflected on the screen display and communication. The arrow not reaching the time axis shows that the signal is processed by other equipment in the image communication apparatus 10.

Part of the screen switched and displayed on the display section 20 with the progress of image communication is schematically indicated on the time axis of the display section 20. The display column involved in the image transmission sequence is selected as appropriate, and is displayed on each screen.

When the call connection is started for transmission of image data (Processing A1), the connection operation display screen 150 appears. When the CED signal has been received from the receiver terminal 45 (Processing B1), transmission starts (Processing A2). The screen of the display section 20 is switched over to the transmission-in-progress screen 100. The progress condition is indicated in the transmission page number display column 109.

Identification information on the receiver terminal 45 is obtained (Processing B2) from the CSI (Called Subscriber Identification) and DIS (Digital Identification Signal) received from the receiver terminal 45. If the identification information is registered in advance, the registered contents are displayed in the transmitting end display column 104 (Processing A3).

The DCS (Digital Command Signal) is sent, and the attribute having been set prior to initiation of transmission is transferred to the receiver terminal 45 (Processing B3).

Network quality is grasped in parallel with transmission operation. If the network quality is poor, the screen display is switched over to the transmission-in-progress screen (congested) 100b, and information on the network quality and remaining continuation time is displayed in the network quality display column 108 and remaining time display column 119 (Processing A4). The user checks the display. If the user has determined that attribute alteration is necessary, he or she sends the instruction to switch the screen. Upon receipt of this instruction, the current display is switched over to the attribute alteration screen 160 (Processing A5). Upon receipt of attribute alteration signal from the attribute alteration screen 160 (Processing A6), the display is switched back to the transmission-in-progress screen (congested) 100b.

Upon receipt of attribute alteration signal (Processing A7), the communication section 26 sends the EOM (End of Message) to the receiver terminal 45 at timed intervals wherein the image data up to the delimiter in the page being transmitted has been transmitted. By doing so, the communication section 26 makes a request to restart the transmission procedure based on T.30 (Processing B4). This arrangement allows the current attribute settings to be reset. New attribute settings are superimposed on the DCS signal and others and are sent to the receiver terminal 45 (Processing B5). The subsequent image data will be sent based on new attributes.

After that, the page number of the data being transmitted is switched (Processing A8) on the transmission-in-progress screen (congested) 100b, or the post-alteration remaining time subsequent to attribute alteration is displayed (Processing A9). Upon completion of image data transmission, call disconnection operation is performed by the image communication apparatus 10 to disconnect the call. The communication terminates upon completion of this operation (Processing A10).

The following describes the second embodiment. In the second embodiment, the image communication apparatus receiving the image data from the external terminal of the transmitter (hereinafter referred to as “transmitter terminal) grasps the network quality of the communication network and progress condition of reception, and displays them.

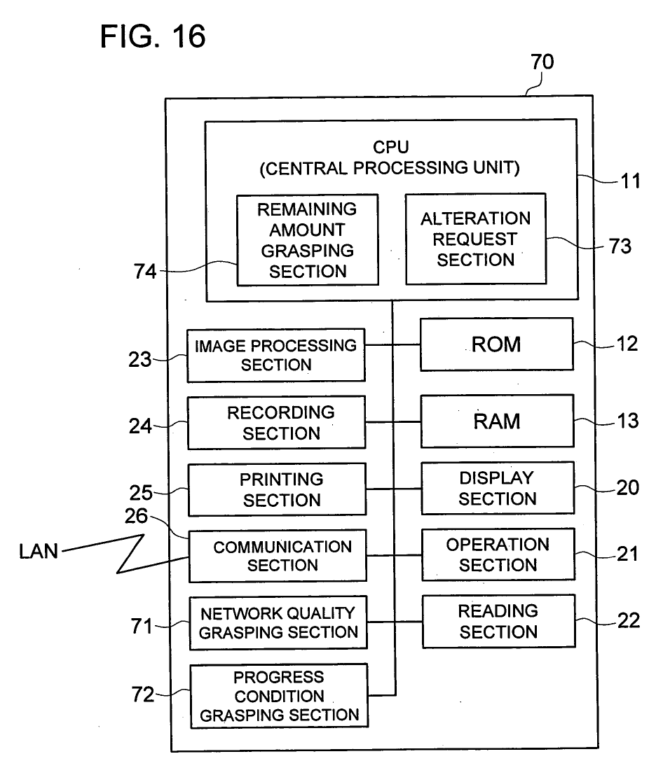

FIG. 16 shows the electrical configuration of the image communication apparatus 70 as a second embodiment of the present invention. The second embodiment will be described with reference to the image communication apparatus 70. It is also possible to make such arrangements that one image communication apparatus has the functions of both the image communication apparatus 10 on the transmitter side shown in the first embodiment and the image communication apparatus 70 on the receiver side shown in the second embodiment.

The image communication apparatus 70 has almost the same configuration as that of the image communication apparatus 10 as the first embodiment shown in FIG. 1. The following describes the difference from that of the first embodiment:

The CPU 11 is connected with the network quality grasping section 71 and progress condition grasping section 72.

The network quality grasping section 71 performs the function of grasping the network quality of the communication network connected to the communication section 26. The network quality grasping section 71 can grasp the network quality of the communication network in the same way as that described with reference to the first embodiment. It is also possible to arrange such a configuration that the network quality grasping section 71 receives from the transmitter terminal the network quality of the communication network grasped by the transmitter terminal, thereby grasping the network quality of the communication network.

The progress condition grasping section 72 provides the function of grasping the progress condition of the image data being received. The progress condition can be any information as long as it contains information on the amount of the image data that have already been received out of the total image data to be received. For example, it is possible to get the number of pages having been received, the amount of data and estimated time, according to the same concept as that of the progress condition in the transmission of image data described with reference to the first embodiment. It is also possible to get information on the percentage of the data having been received when the percentage at the time of completing reception is assumed as 100% for each standard. Further, it is also possible to get the amount of the data having been received in terms of one job, a plurality of jobs or the number of image pages contained on one job. The progress condition displayed on the display section 20 is not restricted to one type. A combination of two or more types can be displayed. The user can selected a desired one out of several selectable alternatives.

For example, in the present embodiment, the progress condition grasped by the progress condition grasping section 72 contains the total number of pages of image data to be received, and the page number being transmitted. For example, the total number of pages is obtained from the information superimposed on the NSS (Non-Standard facilities Setup) signal in the transmission control procedure based on the T.30 by the transmitter terminal. Further, the page number during transmission is acquired by counting the receptions of the MCF signal, subsequent to reception of the MPS signal and EOM signal from the transmitter terminal. Further, the progress condition grasping section 72 incorporates a timer for counting the communication time required from the start of receiving the image data.

The progress condition grasping section 72 can be configured so that the information representing the progress condition in receiving the image data is received from the transmitter terminal. When the transmitter terminal grasps the progress condition on the image data transmission, the contents thereof are obtained. Then the contents can be assumed as the progress condition in receiving the same image data.

The CPU 11 further provides the functions of an alteration request section 73 and a remaining amount grasping section 74.

Using the control information based on the T.30, the transmitter terminal acquires in advance the image mode and resolution that allow attribute alteration. The alteration request section 73 has a function of displaying the contents thereof on the display section 20 wherever required. The alteration request section 73 has a function of requesting the transmitter terminal to provide the contents thereof so that the attribute alteration accepted from the user can be executed. The alteration request section 73 can request the transmitter terminal to provide attribute alteration for both the first and second modes, similarly to the altering section 30 in the first embodiment.

To request the transmitter terminal to alter the attribute of the image data being received, the alteration request section 73 can use the control signal based on T.30. For example, the RTP (ReTrain Positive) signal or RTN (ReTrain Negative) signal is sent during reception of the image data, and a request is made to re-set the receiving conditions. Then the DIS signal to be sent thereafter is used to specify and notify the image mode and resolution, whereby the attribute of the image data to be received can be altered.

The remaining amount grasping section 74 has a function of grasping the remaining amount to be processed before completion of reception, with regard to the image data being received. In the present embodiment, the remaining time before completion of reception can be estimated as the remaining amount to be processed. The remaining time estimated by the remaining amount grasping section 74 refers to the remaining continuation time when reception is continued with regard to the image data being received, without the attribute being altered. Further, the remaining amount grasping section 74 has a function of estimating the post-alteration remaining time as the remaining time when the attribute of the image data being received has been altered in the first altering mode, and the estimated time when reception of the image data is restarted in the second altering mode.

The method of calculating the aforementioned times is the same as that described with reference to the remaining amount grasping section 33 of the first embodiment. The amount of the remaining data for calculating the remaining continuation time and post-alteration remaining time is calculated by the communication section 26 based on the information obtained from the transmitter terminal. For example, the total mount of data is obtained by the NSS signal under transmission control. It is stored in the registry section (not illustrated) provided on the communication section 26, together with the amount of data that has already been received. Thus, the aforementioned times ate obtained by calculating the difference between the total amount of data and the amount of transmitted data.

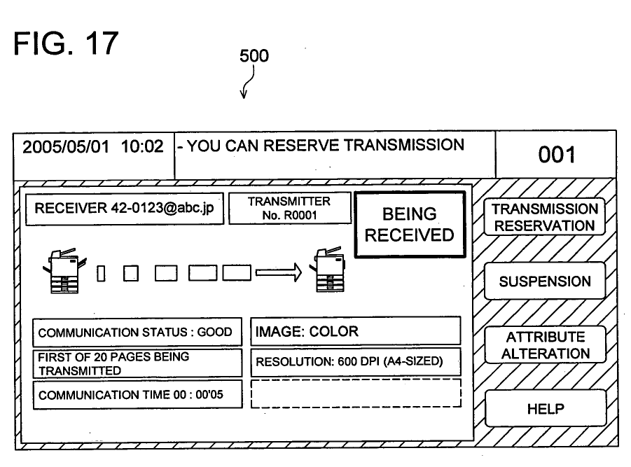

FIG. 17 shows an example of the reception-in-progress screen 500 displayed on the display section 20 during the reception of image data using the facsimile function via the Internet. The reception-in-progress screen 500 is basically the same as the transmission-in-progress screen 100 described with reference to the first embodiment, except that the transmission-related display in the information display section 103 of the transmission-in-progress screen 100 is changed into the reception-related display. The same applies to other screens displayed during reception. Namely, they are almost the same as the screens shown in the display section 20 of the image communication apparatus 10 in the first embodiment.

To show an example of the case where the network quality and progress condition are displayed on the display section 20 during reception of image data, the following describes the case where the image communication apparatus 70 receives the image data from the transmitter terminal by polling. The method by which the image communication apparatus 70 receives the image data is not restricted to the polling method; a normal method for reception of image data can be used.

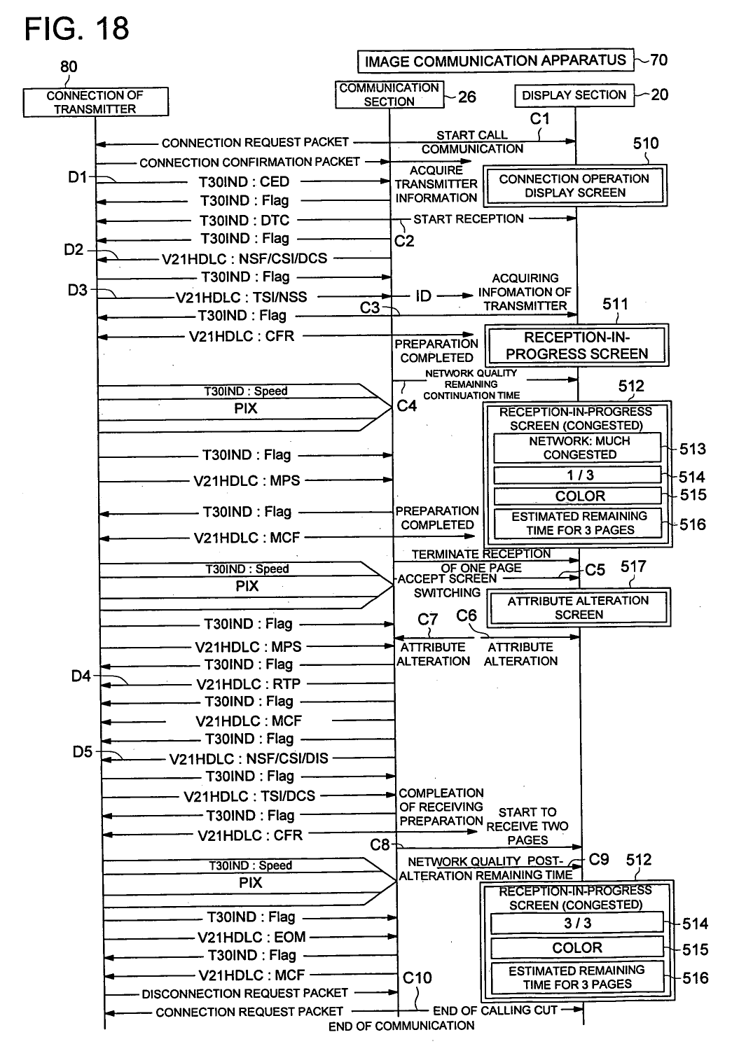

FIG. 18 shows how the screen of the display section of the image communication apparatus is switched and displayed in response to the progress of reception of the image data polling reception sequence. The following describes an example where three-page image data is received in the color mode by polling, and the reception mode is changed to the monochromatic mode in the middle of reception.

The time axes assigned to the display section 20 and communication section 26 of the image communication apparatus 70, and transmitter terminal 80, the arrow mark shown between these time axes, and the indication assigned with the arrow mark have the same meaning as those shown in FIG. 15.

When the communication section 26 starts call connection to receive image data (Processing C1), a connection operation display screen 510 appears. Upon receipt of the CED signal from the sheet conveyance section 80 (Processing D1), reception starts (Processing C2), and the display on the communication section 26 is switched over to the reception-in-progress screen 511. The standard function including the size of the document that can be received using the DIS (Digital Identification Signal) is transmitted. The NSF (Non-Standard Facilities) signal is utilized to send other non-standard functions, and the attribute setting preset prior to the initiation of reception is sent to the transmitter terminal (Processing D2).

The identification information of the transmitter terminal is obtained using the TSI (Transmitting Subscriber Identification) signal having received from the transmitter terminal 80. The total number of pages of the data and the total amount of data are obtained from the image received by the NSS signal (Processing D3). The obtained information is displayed on the reception-in-progress screen 511 (Processing C3).

In parallel with the operation of reception, the network quality is grasped. If the network quality is poor, the screen display is switched over to the reception-in-progress screen (congested) 512, and a warning of “Network much congested” is shown in the network quality display column 513. The remaining continuation time appears in the remaining time display column 516 (Processing C4).

The user checks the display on the reception-in-progress screen (congested) 512. If the user has determined that attribute alteration is necessary, he or she sends the instruction to switch the screen (Processing C5). Upon receipt of this instruction, the current display is switched over to the attribute alteration screen 517. An attribute alteration signal is received for the image data attributes, shown on the attribute alteration screen 517, which can be altered (Processing C6). Then the display is switched back to the transmission-in-progress screen (congested) 512.

Upon receipt of the attribute alteration (Processing C7), the communication section 26 sends the RTP signal or RTN signal to the receiver terminal 80 at timed intervals wherein the image data up to the delimiter position in the page being transmitted has been transmitted. By doing so, the communication section 26 makes a request to restart the setting of the attributes (Processing D4). This arrangement allows the current attribute settings to be reset. New attribute settings are superimposed on the NSF and DIS signals and are sent to the transmitter terminal 80 (Processing D5). The subsequent image data will be sent based on new attributes.

Then the page number of the data being received is switched on the transmission-in-progress screen (congested) 512 (Processing C8), or the post-alteration remaining time subsequent to attribute alteration is displayed (Processing C9). Upon completion of image data reception, call disconnection operation is performed by the image communication apparatus 70 to disconnect the call. The communication terminates upon completion of this operation (Processing C10).

The embodiments of the present invention have been described with reference to drawings. It is to be noted that specific configurations of the present invention are not restricted to those shown in the embodiments. The present invention can be embodied in a great number of variations with appropriate modification or additions, without departing from the technological spirit and scope of the invention claimed.

For example, the image communication apparatus 10 or 70 as the present embodiment carries out image communication using the facsimile function via the Internet. However, the image communication technique is not restricted to this embodiment. The facsimile communication via the public telephone, for example, is also acceptable. In this case, the network quality can be grasped from the result of transmission and reception of the signal for training carried out prior to initiation of image communication.

The image communication apparatus of the present invention is not restricted to the multifunction peripheral having a facsimile function. It is also possible to use the image data transfer based on the FTP (File Transfer Protocol) by a PC. An image communication apparatus based on other image communication technique can also be employed.

The communication network quality grasping method is not restricted to the one explained in the description of the embodiment.

The timed interval for grasping the network quality and progress condition can be changed. For example, such information can be grasped at predetermined intervals on a periodic basis, or at a desired time when the user has depressed the specific button.

The image data input section is not restricted to the reading section 22. The image data can be received from the outside. Alternatively, the image data can be read from a recording medium and be inputted. Other inputting methods can also be used.

Display of the network quality and progress condition by the display section is not restricted to the visual display, as shown in the description of the embodiment. For example, it is also possible to arrange such a configuration that the progress condition is indicated on the display section 20 and an audible alert is issued to notify that the network quality is poor. Any method can be used as long as the user is provided with the aforementioned the information.

In the aforementioned embodiment, the network quality and progress condition are displayed despite the network quality. The time when this display is given is not restricted to the aforementioned time. It is also possible to make such arrangements that the network quality and progress condition are displayed when the predetermined conditions are met, for example, only when the network quality is “Not good”.

In the present embodiment, the remaining time is displayed in the case of poor network quality. The time when this information is displayed is not limited to the example used in the present embodiment. It is also possible to make such arrangements that both the network quality and remaining time are displayed at all times.

The network quality and progress condition, or network quality and remaining time need not be displayed simultaneously. For example, it is also possible to indicate only the network quality on the display section 20, and to display the progress condition and remaining time additionally in response to the user's request. Conversely, it is also possible to indicate only the progress condition and remaining time, and to display the network quality additionally in response to the user's request. In this case, switching can be carried out between the network quality display screen, and the progress condition and remaining time display screen.

The attributes that can be altered by the altering section 30 are not restricted to the example shown in the embodiment. For example, it is also possible to alter the encoding method for compressing the image data.

The method for attribute alteration that can be achieved by the altering section 30 is not restricted to the downgrading method wherein the color mode is switched to the monochromatic mode, or the resolution is reduced in order to reduce the amount of image data. It is also possible to make such arrangements that the setting mode can be upgraded. To put it more specifically, when resolution is reduced by attribute alteration due to poor network quality, the resolution is brought back to the original level in the middle of transmission if the network quality has recovered to the satisfactory level. Such a configuration is also acceptable.

When it has been found out according to the information gained from the display section 20 that transmission requires less time than originally estimated, attribute alteration is carried out to improve resolution for transmission, and the monochromatic mode is changed to the color mode for transmission. Such a configuration is also possible.

According to the aforementioned embodiment, the attribute alteration screen 160 for altering the attribute and the re-transmission attribute setting screen 180 are displayed in response to the user's request. It is also possible to make such arrangements that they are displayed automatically when the network quality grasping section 31 or 71 has determined that the network quality is poor. This reduces the user's load in making a decision.

When re-transmitting all the pages displayed on the re-transmission attribute setting screen 180 illustrated in FIG. 14, the remaining time can be displayed in conformity to the attribute alteration screen 160 illustrated in FIG. 12. This arrangement allows the user to determine the altering mode after making comparison between the remaining time when the first altering mode have been selected, and the remaining time when the second altering mode have been selected.

The image communication apparatus of the present invention displays the network quality and progress condition related to transmission or reception, or the network quality and the remaining amount of processing related to transmission or reception. This arrangement allows the user to determine the step to be taken, after making comparison of the aforementioned items of information.

While the preferred embodiments of the present invention have been described using specific term, such description is for illustrative purpose only, and it is to be understood that changes and variations may be made without departing from the spirit and scope of the appended claims.

What is claimed is:

1. An image communication apparatus, comprising:
a transmission section which transmits image data to an external device via a network;
a network quality grasping section which grasps a quality of the network;
a progress condition grasping section which grasps a progress condition of a transmission of image data with regard to the image data being transmitted by the transmission section; and
a display section which displays the quality of the network and the progress condition of transmission of the image data during transmission of the image data.

2. The image communication apparatus of claim 1,
wherein the display section displays the quality of the network and the progress condition of transmission of the image data simultaneously.

3. The image communication apparatus of claim 1,
wherein the display section displays an estimated remaining time required for completion of a transmission of the image data being transmitted by the transmission section.

4. The image communication apparatus of claim 1,
wherein the display section displays a warning, when the quality of the network does not meet a predetermined condition.

5. The image communication apparatus of claim 1,
wherein the display section displays selectable alternatives with regard to an attribute of the image data during transmission of the image data, and
wherein the image communication apparatus further comprises
an altering section which alters an attribute of the image data to be transmitted based on a selection among the selectable alternatives.

6. The image communication apparatus of claim 5,
wherein the display section displays the selectable alternatives, when the quality of the network does not meet a predetermined condition and during transmission of the image data.

7. The image communication apparatus of claim 5,
wherein the display section displays a plurality of estimated remaining time required for completion of a transmission of the image data corresponding to the selectable alternatives; and
wherein each estimated remaining time is calculated based on each selectable alternative in case each selectable alternative is selected during the transmission.

8. The image communication apparatus of claim 5,
wherein the display section displays a plurality of estimated time required for completion of a transmission of the image data corresponding to the selectable alternatives, and wherein each estimated time is calculated based on each selectable alternative in case each selectable alternative is selected, and the image data is re-transmitted based on a selected attribute.

9. The image communication apparatus of claim 5,
wherein the image communication apparatus functions in a first altering mode, where an attribute of the image data being transmitted is altered and a transmission of the image data is continued, and a second altering mode, where an attribute of the image data being transmitted is altered and the image data is re-transmitted based on an altered attribute.

10. The image communication apparatus of claim 1,
wherein the display section displays an elapsed time after starting a transmission of the image data during the transmission thereof.

11. An image communication apparatus, comprising:
a transmission section which transmits image data to an external device via a network;
a network quality grasping section which grasps a quality of the network;
a progress condition grasping section which grasps a progress condition of a job for transmitting image data; and
a display section which displays the quality of the network and the progress condition of transmission of the image data during execution of the job.

12. The image communication apparatus of claim 11,
wherein the display section displays the quality of the network and the progress condition of transmission of the image data simultaneously.

13. The image communication apparatus of claim 11,
wherein the display section displays an estimated remaining time required for completion of a transmission of the image data being transmitted by the transmission section.

14. The image communication apparatus of claim 11,
wherein the display section displays a warning, when the quality of the network does not meet a predetermined condition.

15. The image communication apparatus of claim 11,
wherein the display section displays selectable alternatives with regard to an attribute of the image data during transmission of the image data, and
wherein the image communication apparatus further comprises
an altering section which alters an attribute of the image data to be transmitted based on a selection among the selectable alternatives.

16. The image communication apparatus of claim 15,
wherein the display section displays the selectable alternatives, when the quality of the network does not meet a predetermined condition and during transmission of the image data.

17. The image communication apparatus of claim 15,
wherein the display section displays a plurality of estimated remaining time required for completion of a transmission of the image data corresponding to the selectable alternatives; and
wherein each estimated remaining time is calculated based on each selectable alternative in case each selectable alternative is selected during the transmission.

18. The image communication apparatus of claim 15,
wherein the display section displays a plurality of estimated time required for completion of a transmission of the image data corresponding to the selectable alternatives, and wherein each estimated time is calculated based on each selectable alternative in case each selectable alternative is selected, and the image data is re-transmitted based on a selected attribute.

19. The image communication apparatus of claim 15,
wherein the image communication apparatus functions in a first altering mode, where an attribute of the image data being transmitted is altered and a transmission of the image data is continued, and a second altering mode, where an attribute of the image data being transmitted is altered and the image data is re-transmitted based on an altered attribute.

20. The image communication apparatus of claim 11,
wherein the display section displays an elapsed time after starting a transmission of the image data during the transmission thereof.

21. An image communication apparatus, comprising:
a transmission section which transmits image data to an external device via a network;
a network quality grasping section which grasps a quality of the network;
a remaining amount grasping section which grasps remaining amount for completion of a transmission of image data with regard to the image data being transmitted by the transmission section; and
a display section which displays the quality of the network and the remaining amount of transmission of the image data during transmission of the image data.

22. The image communication apparatus of claim 21,
wherein the display section displays the quality of the network and the remaining amount of transmission of the image data simultaneously.

23. The image communication apparatus of claim 21,
wherein the display section displays a warning, when the quality of the network does not meet a predetermined condition.

24. The image communication apparatus of claim 21,
wherein the display section displays selectable alternatives with regard to an attribute of the image data during transmission of the image data, and
wherein the image communication apparatus further comprises
an altering section which alters an attribute of the image data to be transmitted based on a selection among the selectable alternatives.

25. The image communication apparatus of claim 24,
wherein the display section displays the selectable alternatives, when the quality of the network does not meet a predetermined condition and during transmission of the image data.

26. The image communication apparatus of claim 24,
wherein the display section displays a plurality of estimated remaining time required for completion of a transmission of the image data corresponding to the selectable alternatives; and
wherein each estimated remaining time is calculated based on each selectable alternative in case each selectable alternative is selected during the transmission.

27. The image communication apparatus of claim 24,
wherein the display section displays a plurality of estimated time required for completion of a transmission of the image data corresponding to the selectable alternatives, and wherein each estimated time is calculated based on each selectable alternative in case each selectable alternative is selected, and the image data is re-transmitted based on a selected attribute.

28. The image communication apparatus of claim 24,
wherein the image communication apparatus functions in a first altering mode, where an attribute of the image data being transmitted is altered and a transmission of the image data is continued, and a second altering mode, where an attribute of the image data being transmitted is altered and the image data is re-transmitted based on an altered attribute.

29. The image communication apparatus of claim 21,
wherein the display section displays an elapsed time after starting a transmission of the image data during the transmission thereof.

30. An image communication apparatus, comprising:
a transmission section which transmits image data to an external device via a network;
a network quality grasping section which grasps a quality of the network;
a remaining amount grasping section which grasps remaining amount for completion of a job for transmitting image data; and
a display section which displays the quality of the network and the remaining amount of transmission of the image data during execution of the job.

31. The image communication apparatus of claim 30,
wherein the display section displays the quality of the network and the remaining amount of transmission of the image data simultaneously.

32. The image communication apparatus of claim 30,
wherein the display section displays a warning, when the quality of the network does not meet a predetermined condition.

33. The image communication apparatus of claim 30,
wherein the display section displays selectable alternatives with regard to an attribute of the image data during transmission of the image data, and
wherein the image communication apparatus further comprises
an altering section which alters an attribute of the image data to be transmitted based on a selection among the selectable alternatives.

34. The image communication apparatus of claim 33,
wherein the display section displays the selectable alternatives, when the quality of the network does not meet a predetermined condition and during transmission of the image data.

35. The image communication apparatus of claim 33,
wherein the display section displays a plurality of estimated remaining time required for completion of a transmission of the image data corresponding to the selectable alternatives; and
wherein each estimated remaining time is calculated based on each selectable alternative in case each selectable alternative is selected during the transmission.

36. The image communication apparatus of claim 33,
wherein the display section displays a plurality of estimated time required for completion of a transmission of the image data corresponding to the selectable alternatives, and wherein each estimated time is calculated based on each selectable alternative in case each selectable alternative is selected, and the image data is re-transmitted based on a selected attribute.

37. The image communication apparatus of claim 33,
wherein the image communication apparatus functions in a first altering mode, where an attribute of the image data being transmitted is altered and a transmission of the image data is continued, and a second altering mode, where an attribute of the image data being transmitted is altered and the image data is re-transmitted based on an altered attribute.

38. The image communication apparatus of claim 30,
wherein the display section displays an elapsed time after starting a transmission of the image data during the transmission thereof.

39. An image communication apparatus, comprising:
a reception section which receives image data from an external device via a network;
a network quality grasping section which grasps a quality of the network;
a progress condition grasping section which grasps a progress condition of a reception of image data with regard to the image data being received by the reception section; and
a display section which displays the quality of the network and the progress condition of reception of the image data during reception of the image data.

40. The image communication apparatus of claim 39,
wherein the display section displays the quality of the network and the progress condition of transmission of the image data simultaneously.

41. The image communication apparatus of claim 39,
wherein the display section displays an estimated remaining time required for completion of a transmission of the image data being received by the reception section.

42. The image communication apparatus of claim 39,
wherein the display section displays a warning, when the quality of the network does not meet a predetermined condition.

43. The image communication apparatus of claim 39,
wherein the display section displays selectable alternatives with regard to an attribute of the image data during reception of the image data, and wherein the image communication apparatus further comprises
a request section which requests an external device being transmitting the image data to alter an attribute of the image data based on a selection among the selectable alternatives.

44. The image communication apparatus of claim 43,
wherein the display section displays the selectable alternatives, when the quality of the network does not meet a predetermined condition and during reception of the image data.

45. The image communication apparatus of claim 43,
wherein the display section displays a plurality of estimated remaining time-required for completion of a reception of the image data corresponding to the selectable alternatives, and wherein each estimated remaining time is calculated based on each selectable alternative in case each selectable alternative is selected during the reception.

46. The image communication apparatus of claim 43,
wherein the display section displays a plurality of estimated time required for completion of a reception of the image data corresponding to the selectable alternatives, and wherein each estimated time is calculated based on each selectable alternative in case each selectable alternative is selected, and the image data is re-received based on a selected attribute.

47. The image communication apparatus of claim 43,
wherein the image communication apparatus functions in a first altering mode, where an attribute of the image data being received is altered and a reception of the image data is continued, and a second altering mode, where an attribute of the image data being received is altered and the image data is re-received based on an altered attribute.

48. The image communication apparatus of claim 39,
wherein the display section displays an elapsed time after starting a reception of the image data during the reception thereof.

49. An image communication apparatus, comprising:
a reception section which receives image data from an external device via a network;
a network quality grasping section which grasps a quality of the network;
a progress condition grasping section which grasps a progress condition of a job for reception image data; and
a display section which displays the quality of the network and the progress condition of reception of the image data during execution of the job.

50. The image communication apparatus of claim 49,
wherein the display section displays the quality of the network and the progress condition of transmission of the image data simultaneously.

51. The image communication apparatus of claim 49,
wherein the display section displays an estimated remaining time required for completion of a transmission of the image data being received by the reception section.

52. The image communication apparatus of claim 49,
wherein the display section displays a warning, when the quality of the network does not meet a predetermined condition.

53. The image communication apparatus of claim 49,
wherein the display section displays selectable alternatives with regard to an attribute of the image data during reception of the image data, and wherein the image communication apparatus further comprises
a request section which requests an external device being transmitting the image data to alter an attribute of the image data based on a selection among the selectable alternatives.

54. The image communication apparatus of claim 53,
wherein the display section displays the selectable alternatives, when the quality of the network does not meet a predetermined condition and during reception of the image data.

55. The image communication apparatus of claim 53,
wherein the display section displays a plurality of estimated remaining time required for completion of a reception of the image data corresponding to the selectable alternatives, and wherein each estimated remaining time is calculated based on each selectable alternative in case each selectable alternative is selected during the reception.

56. The image communication apparatus of claim 53,
wherein the display section displays a plurality of estimated time required for completion of a reception of the image data corresponding to the selectable alternatives, and wherein each estimated time is calculated based on each selectable alternative in case each selectable alternative is selected, and the image data is re-received based on a selected attribute.

57. The image communication apparatus of claim 53,
wherein the image communication apparatus functions in a first altering mode, where an attribute of the image data being received is altered and a reception of the image data is continued, and a second altering mode, where an attribute of the image data being received is altered and the image data is re-received based on an altered attribute.

58. The image communication apparatus of claim 49,
wherein the display section displays an elapsed time after starting a reception of the image data during the reception thereof.

59. An image communication apparatus, comprising:
a reception section which receives image data from an external device via a network;
a network quality grasping section which grasps a quality of the network;
a remaining amount grasping section which grasps remaining amount for completion of a reception of image data with regard to the image data being received by the reception section; and
a display section which displays the quality of the network and the remaining amount of reception of the image data during reception of the image data.

60. The image communication apparatus of claim 59,
wherein the display section displays the quality of the network and the remaining amount of transmission of the image data simultaneously.

61. The image communication apparatus of claim 59,
wherein the display section displays a warning, when the quality of the network does not meet a predetermined condition.

62. The image communication apparatus of claim 59,
wherein the display section displays selectable alternatives with regard to an attribute of the image data during reception of the image data, and wherein the image communication apparatus further comprises
a request section which requests an external device being transmitting the image data to alter an attribute of the image data based on a selection among the selectable alternatives.

63. The image communication apparatus of claim 62,
wherein the display section displays the selectable alternatives, when the quality of the network does not meet a predetermined condition and during reception of the image data.

64. The image communication apparatus of claim 62,
wherein the display section displays a plurality of estimated remaining time required for completion of a reception of the image data corresponding to the selectable alternatives, and wherein each estimated remaining time is calculated based on each selectable alternative in case each selectable alternative is selected during the reception.

65. The image communication apparatus of claim 62,
wherein the display section displays a plurality of estimated time required for completion of a reception of the image data corresponding to the selectable alternatives, and wherein each estimated time is calculated based on each selectable alternative in case each selectable alternative is selected, and the image data is re-received based on a selected attribute.

66. The image communication apparatus of claim 62,
wherein the image communication apparatus functions in a first altering mode, where an attribute of the image data being received is altered and a reception of the image data is continued, and a second altering mode, where an attribute of the image data being received is altered and the image data is re-received based on an altered attribute.

67. The image communication apparatus of claim 59,
wherein the display section displays an elapsed time after starting a reception of the image data during the reception thereof.

68. An image communication apparatus, comprising:
a reception section which receives image data from an external device via a network;
a network quality grasping section which grasps a quality of the network;
a remaining amount grasping section which grasps remaining amount for completion of a job for reception image data; and
a display section which displays the quality of the network and the remaining amount of reception of the image data during execution of the job.

69. The image communication apparatus of claim 68,
wherein the display section displays the quality of the network and the remaining amount of transmission of the image data simultaneously.

70. The image communication apparatus of claim 68,
wherein the display section displays a warning, when the quality of the network does not meet a predetermined condition.

71. The image communication apparatus of claim 68,
wherein the display section displays selectable alternatives with regard to an attribute of the image data during reception of the image data, and wherein the image communication apparatus further comprises
a request section which requests an external device being transmitting the image data to alter an attribute of the image data based on a selection among the selectable alternatives.

72. The image communication apparatus of claim 71,
wherein the display section displays the selectable alternatives, when the quality of the network does not meet a predetermined condition and during reception of the image data.

73. The image communication apparatus of claim 71,
wherein the display section displays a plurality of estimated remaining time required for completion of a reception of the image data corresponding to the selectable alternatives, and wherein each estimated remaining time is calculated based on each selectable alternative in case each selectable alternative is selected during the reception.

74. The image communication apparatus of claim 71,
wherein the display section displays a plurality of estimated time required for completion of a reception of the image data corresponding to the selectable alternatives, and wherein each estimated time is calculated based on each selectable alternative in case each selectable alternative is selected, and the image data is re-received based on a selected attribute.

75. The image communication apparatus of claim 71,
wherein the image communication apparatus functions in a first altering mode, where an attribute of the image data being received is altered and a reception of the image data is continued, and a second altering mode, where an attribute of the image data being received is altered and the image data is re-received based on an altered attribute.

76. The image communication apparatus of claim 68,
wherein the display section displays an elapsed time after starting a reception of the image data during the reception thereof.
